(19) United States
(12) Patent Application Publication
(10) Pub. No.: US 2025/0383627 A1
(43) Pub. Date: Dec. 18, 2025

(54) METHOD FOR THE REPLICATION OF A HOLOGRAM BY MEANS OF AN OPTICAL ADHESIVE FILM

(71) Applicant: Carl Zeiss Jena GmbH, Jena (DE)

(72) Inventors: Stefan Schwedat, Jena (DE); Mirko Riethmüller, Jena (DE); Markus Giehl, Jena (DE)

(21) Appl. No.: 18/877,245

(22) PCT Filed: Jun. 22, 2023
(86) PCT No.: PCT/EP2023/066968

§ 371 Date: Dec. 19, 2024

(30) Foreign Application Priority Data
Jun. 22, 2022 (DE) 10 2022 115 524.2

(51) Int. Cl. G03H 1/20; G03H 1/02; G03H 1/04

(52) U.S. Cl. CPC G03H 1/202; G03H 1/0256; G03H 1/0402; G03H 2001/026; G03H 2227/04; G03H 2250/35

(57) ABSTRACT

A method for replicating a hologram in a light-sensitive composite web comprises providing a master element comprising a substrate body and at least one master hologram, applying a light-sensitive composite web on a surface of the master element, exposing the master element in order to replicate the at least one master hologram into the light-sensitive composite web and detaching the exposed composite web from the master element. The method also comprises the temporary application of an optical adhesive film between the light-sensitive composite web and the surface of the master element. The optical adhesive film imparts optical contact between the master element and the light-sensitive composite web during the exposure. Another method for replicating a hologram in a light-sensitive composite web comprises using an input coupling element, wherein an optical adhesive film is introduced between the composite web and the input coupling element.

The invention relates to a method for replicating a hologram in a light-sensitive composite web. The method according to the invention preferably comprises the provision of a master element comprising a substrate body and at least one master hologram, the application of a light-sensitive composite web on a surface of the master element, the exposure of the master element in order to replicate the at least one master hologram into the light-sensitive composite web and the detachment of the exposed composite web from the master element. The method also comprises the temporary application of an optical adhesive film between the light-sensitive composite web and the surface of the master element. The optical adhesive film imparts optical contact between the master element and the light-sensitive composite web during the exposure. In a further aspect, the invention relates to a method for replicating a hologram in a light-sensitive composite web using an input coupling element, wherein an optical adhesive film is introduced between the composite web and the input coupling element.

### BACKGROUND AND PRIOR ART

The invention relates to the field of replication of holograms.

HOEs (Holographic Optical Elements) typically denote optical components in which holographic properties are used to attain a specific beam path of the light, such as e.g. transmission, reflection, diffraction, scattering and/or deflection, etc. As a result, desired optical functionalities can be implemented in arbitrary substrates in a compact manner. The holographic properties preferably exploit the wave nature of light, in particular coherence and interference effects. Both the intensity and the phase of the light are taken into account here.

Such holographic elements find application in many fields, such as e.g. in transparent displays (e.g. in display windows, refrigeration equipment, vehicle windowpanes), for illumination applications, such as information or warning signals in glass surfaces, light-sensitive detection systems for example for interior monitoring (eye tracking in vehicles or presence status tracking of persons in interiors).

Holograms are generated by the interference of a reference beam with the light reflected or diffracted by the surface of an object (object beams). Three-dimensional objects have traditionally been used in order to produce unique, customized holograms. By contrast, commercially available HOEs are often produced by means of replication methods in mass production. Such replication methods generally use a master hologram having the image to be copied. The master holograms used are often stored in a substrate body bearing the master hologram. The substrate body is preferably transparent and can have various shapes, for example a parallelepipedal shape, a plate or a roller. The combination of the master hologram with the substrate body forms a master element.

The master element is exposed using a coherent light source in order to replicate the image from the master hologram in a light-sensitive composite. For mass production, the light-sensitive composite can be provided in the form of a traveling web comprising a light-sensitive material and one or more carrier or protective layers. For this purpose, the light-sensitive web is preferably transported through various work stations in order to produce the HOEs.

During the exposure, the composite web is placed onto a surface of the master element. In order to create a reflection hologram, the coherent light can traverse the composite web before it reaches the master hologram and is reflected by the latter back into the composite web. In order to create a transmission hologram, the coherent light can alternatively be directed at the master hologram first, by means of which it is diffracted before it reaches the composite web. In both cases, object and reference beams interfere with one another in the light-sensitive material and form the replicated hologram. The process of replication is sensitive to unwanted disturbance light, which is also capable of interfering with the object and/or reference beams. For example, should irregularities or gaps arise at the interface between the composite web and the surface of the master element, the reference and/or object beams can be subject to internal reflection. This can lead either to losses of light or to unwanted interferences that impair the quality of the replicated hologram. The provision of sufficiently optical contact between the master element and the composite web is therefore very relevant to the quality of the replicated hologram.

This also applies to the possible use in the exposure process of input coupling elements, which are used for hologram replication in certain configurations. For example, input coupling elements can preferably be used to adjust an exposure angle. The exposure angle, i.e. the angle at which the object and reference beams are incident on the light-sensitive material, also determines the angle at which the hologram can be reconstructed. Thus, varying the exposure angle allows the production of different types of holograms, for example: edge-lit holograms, back-lit holograms, holograms at eye level or holograms that are only visible from below, etc.

The exposure angle can be varied or adjusted by virtue of guiding the coherent light, which is used to expose the hologram, through an input coupling element. The input coupling element is transparent at least to the wavelength of the exposure beam and can assume different shapes, for example a cuboid shape, a plate, a pyramid, a roller, etc. Moreover, the input coupling element can be placed on the composite web such that the light is initially diffracted by the input coupling element material in order to obtain a desired angle of approach on the composite web. However, there can be internal reflection of light should small gaps be present at the interface or boundary between the input coupling element and the composite web. This also leads to unwanted interferences or losses. Thus, virtually perfect optical contact between the input coupling element and the composite web is also desirable in such setups, in order to create high-quality replicated holograms.

The use of index matching liquids has been proposed in order to improve the optical contact between the composite web and the adjacent components (e.g. master elements or input coupling elements) in an exposure process. WO 9619754 A1 teaches a method for replicating a master hologram from a hollow drum-shaped master element in a composite web. The composite web travels concurrently over a curved surface of the rotating master element. It was established in this case that image artifacts were created by internal reflections at air/glass or air/substrate interfaces in the event of insufficient optical contact between the components. To improve the optical contact between the composite web and the master element, an index matching liquid such as xylene is guided continuously onto the surface of the master element. The liquid fills gaps between the master element and the composite web. In addition, the composite web is submersed in an index matching liquid prior to the exposure. Following the exposure, the liquid must be removed from the composite web before the latter can be rolled up or processed further.

However, a disadvantage of the proposed method is that xylene is an easily inflammable irritant and suspected of being carcinogenic, and so its use requires greater system complexity in order to ensure explosion prevention, environmental protection and industrial safety. Moreover, the complexity and the outlay of the HOE production process is increased on account of the required removal of the index matching liquid.

JP2000250386A also discloses the use of an index matching liquid for the purpose of improving the optical contact between a master element and a light-sensitive composite web. The index matching liquid cannot be too volatile as it must remain in the liquid phase for the duration of the coating and exposure process. However, the index matching liquid is dried prior to further processing of the exposed composite web. Once again, this is accompanied by a significant increase in the system complexity. Moreover, a liquid index matching means must be very thin so that the molecule motion in the liquid film does not modify the phase angle of the passing light, as this would in turn have a negative effect on the hologram quality. As a rule, the index matching liquid is lost even upon removal, and so it cannot be reused. This additionally increases the overall process costs.

Semi-volatile index matching liquids that do not dry quickly can remain on the surfaces of the master hologram or other component parts for longer. This may necessitate cleaning of the master hologram in order to avoid an accumulation of liquids and contaminants. This cleaning step can be complicated, especially if the master hologram has a non-smooth surface (e.g. a relief pattern). The prior art offers only limited solutions as regards the protection of the surfaces of master holograms in the event of these coming into contact with liquid or resinous materials.

The use of optically transparent layers for protecting a master hologram from contamination during an exposure method is known. DE 10 2006 016 139 A1 has disclosed the use of a transparent detachment layer between a resinous (non-solid) photosensitive layer and a master hologram. The detachment layer should facilitate a removal of the resinous photosensitive layer from the master hologram. To keep the optical influence of the detachment layer small, provision is made for the refractive index difference between the photosensitive layer and the detachment layer to be kept small or avoided entirely. Thus, the detachment layer should not have any optical power.

Moreover, the detachment layer can serve as a capping layer for the relief structure of the master hologram. Despite the detachment layer, which is represented as being very thin, the relief structure of the master hologram remains sharp and can be pressed into the photosensitive layer. DE 10 2006 016 139 A1 suggests that the detachment layer is a coating that is applied permanently to a surface of the master hologram.

In order to integrate the exposed hologram in a product, DE 10 2006 016 139 A1 moreover describes the use of an adhesive layer which bonds the replicated hologram to a substrate. In contrast to the detachment layer, the adhesive layer remains as a permanent constituent of the product, from which the hologram can no longer be removed.

In the field of optical displays, the use of “optical clearance adhesives” (OCAs) for the purpose of bonding a background illumination to a screen is also known.

KR20150001411A teaches an example of such an OCA for use in an LCD screen. The OCA comprises an adhesive and prevents the formation of an air layer between the background illumination and the LCD screen. Similarly, U.S. Pat. No. 10,611,937B2 teaches an adhesive layer that serves to securely bond a glass layer to a sensor film of a screen. The adhesive layer comprises an OCA in order to ensure a good optical performance of the screen. The intention is for such an adhesive layer to permanently bond the layers of the screen to one another in order to ensure a long service life of the product. There is no provision for adhesive layer removal.

Furthermore, DE 10 2019 112 254 A1 has disclosed a transparent multi-layer microfluidic arrangement. The different layers of the arrangement are bonded to one another by means of a transparent adhesive. Microfluidic channels are created by clamping a wall structure between a transparent, flexible capping layer and a base layer. The optical refractive indices of the layer materials are chosen so as to make the layer structure imperceptible. This should facilitate the readout of the microfluidic results. As regards the creation of the adhesive layer, a hot-melt adhesive is proposed. In some embodiments, in order to set its local adherence properties, the adhesive layer is exposed to UV radiation. This adhesive layer is also configured for a permanent bond.

In view of the prior art, methods for reproducing holograms in a light-sensitive material thus need to be improved in view of efficiency, economy and optical quality of the replicated holograms. In particular, there is a need for an improvement in the optical contact between the light-sensitive composite web and the adjacent optical components such as the master element or the input coupling elements, which reliably ensures exposure without disturbances, which does not require dangerous chemicals or excessive cleaning, which can be removed without residue and which is easy to handle.

### OBJECT OF THE INVENTION

The problem addressed by the invention is that of providing a method without the disadvantages of the prior art, for replicating a hologram from a master element in a light-sensitive composite web. In particular, one problem addressed by the invention was that of providing an optically very precise and high-quality method suitable for material-friendly replication of holograms on a light-sensitive composite web.

### SUMMARY OF THE INVENTION

The problem is solved by the features of the independent claims. Advantageous configurations of the invention are described in the dependent claims.

In a first aspect, the invention relates to a method for replicating a hologram in a light-sensitive composite web, comprising the following steps:
a. providing a master element comprising a substrate body and at least one master hologram,
b. applying a light-sensitive composite web to a surface of the master element,
c. exposing the master element in order to replicate the at least one master hologram in the light-sensitive composite web, and
d. detaching the exposed composite web from the master element.

Further, the method according to the invention comprises a temporary application of an optical adhesive film between the light-sensitive composite web and the surface of the master element, said optical adhesive film imparting optical contact between the master element and the light-sensitive composite web preferably while the master element is being exposed.

In a further aspect, the invention relates to a method for replicating a hologram in a light-sensitive composite web, comprising the following steps:
a. providing a master element comprising a substrate body and at least one master hologram,
b. applying a light-sensitive composite web to a surface of the master element,
c. applying an input coupling element to the light-sensitive composite web such that the light-sensitive composite web is positioned between a surface of the input coupling element and the surface of the master element,
d. exposing the master element with the aid of the input coupling element in order to replicate the at least one master hologram in the light-sensitive composite web,
e. detaching the input coupling element from the exposed composite web, and
f. detaching the exposed composite web from the master element.

Further, the method comprises a temporary application of an optical adhesive film between the light-sensitive composite web and the surface of the input coupling element, said optical adhesive film imparting optical contact between the input coupling element and the light-sensitive composite web preferably while the master element is being exposed.

The advantage of the method according to the invention is that of ensuring virtually flawless optical contact between a master element (or an input coupling element) and the light-sensitive composite web, without requiring additional steps for purging or evaporating an index matching liquid. Instead, an optical adhesive film, which can be removed without residue, can establish a smooth gap-free transition between the master element (or the input coupling element) and the composite web, and so there is substantially no unwanted reflections or scattering at interfaces between the components. This reduces optical losses and minimizes a possible appearance of optical disturbances that could leave unwanted patterns in the replicated hologram. It is also particularly advantageous that the optical adhesive film can adhere sufficiently to both the master element and the light-sensitive composite web to prevent the occurrence of bubbles or air gaps. At the same time, the optical adhesive film is applied to the master element only temporarily, and so the surface of the master element does not allow potential contamination to adhere.

Furthermore, the “optical adhesive film” is preferably a solid in which Brownian motion of the molecules is sufficiently small, whereby a “wobble” of the phase of the light is prevented; this thus yields a more stable interference field in the hologram copy within the exposure time. In this way, the microstructures do not smear, whereby the diffraction efficiency of the holograms is maximal. The sharpness and the contrast of the created hologram are also substantially improved. By preference, the optical adhesive film is configured such that it adheres to a surface of the composite web and an adjacent surface of the master element and/or input coupling element. The strength of the adhesion is preferably so high that a gap-free bond can be attained between the composite web and the adjacent component without the need for exerting more pressure on the composite web than would otherwise be the case for bringing the latter into contact with these elements. It is particularly preferred that the composite web need not be pressed on the master element or input coupling element so strongly that a material deformation arises. Hence, the method according to the invention also differs in this point from the method of DE 10 2006 016 139 A1, in which a deformable layer needs to be pressed on the detachment/capping layer of a master hologram. At the same time, the strength of the adhesion of the optical adhesive film on these components should preferably be so low that the optical adhesive film can be removed without damage or residue. In this sense, the optical adhesive film of the invention preferably further differs from the adhesive layers in the prior art such as DE 10 2006 016 139 A1, KR20150001411A, U.S. Pat. No. 10,611,937B2 and DE 10 2019 112 254 A1, which are designed for a permanent adhesive bond.

Moreover, the optical adhesive film is preferably provided in the form of a foil or a film. That is to say, it is not the case that the material of the optical adhesive film only forms a film or foil upon application (e.g. by spraying) on the surface of a process component. Instead, the optical adhesive film preferably already has a defined width and thickness before it is applied to or between process components. Hence, the optical adhesive film according to the invention differs from protective or detachment layers as known from DE 10 2006 016 139 A1, which are permanently applied to a surface of the master hologram by coating. By preference, the optical adhesive film is provided in the form of a roll, even though other embodiments, e.g. a loop or a number of individual stickers, are also possible.

A further advantage of the method according to the invention lies in the fact that the materials used for the optical adhesive film can have identical or similar optical properties to those of the materials used for the substrate of the master element (or for the input coupling element) and/or the composite web. By preference, the similar or identical properties comprise transparency, haze, stress birefringence properties and/or the refractive index. The use of identical or similar materials allows very close matching of the refractive index of the optical adhesive film to the refractive indices of the adjacent process components, and so it is possible to ensure a transition between the adjacent refractive indices without refractive index jumps. This largely eliminates or significantly minimizes reflections at the interface between the master element (or the input coupling element), the optical adhesive film and/or the light-sensitive composite web.

Moreover, optical contacting by means of an optical adhesive film allows the exposure to be easily integrated in a continuous production process, preferably in a roll-to-roll method. The optical adhesive film can be formed in a manner analogous to the composite web and can be moved through the process in analogous fashion, e.g. with the aid of rollers. This enables simple synchronization of the optical adhesive film with the composite web. It is also possible and can be preferable that the optical adhesive film and/or the light-sensitive composite web is applied to the surface of the master element or the surface of the input coupling element by a lamination roller. During the exposure, the optical adhesive film is preferably in mechanical contact with the light-sensitive composite web and the master element and/or input coupling element. By preference, the optical adhesive film is removed both from the light-sensitive composite web and from the master element and/or input coupling element post exposure. Thus, the optical adhesive film is preferably not a permanent constituent part of the light-sensitive composite web, of the master element or of the input coupling element.

Optical adhesive films can be precisely specified in terms of their layer thickness, layer thickness homogeneity and waviness. For example, the optical adhesive film can be advantageously provided with a desired, constant thickness such that the intensity of the light used to expose the composite web remains uniform throughout. By contrast, the dose may vary over time if index matching liquids are used, and there is no guarantee of the liquid being distributed uniformly over the desired surfaces. A similar problem can arise in the application of hot-melt adhesives, as these are also metered in liquid form. The application of an optical adhesive film according to the invention allows a distance between a composite web and a master element and/or input coupling element to be bridged particularly precisely. Further, the use of an optical adhesive film with correspondingly specifiable layer thickness, layer thickness homogeneity and waviness leads to high process stability in the copying process. In particular, surfaces of the optical adhesive film can be configured to be substantially free from waviness. This avoids variations in the adhesive film thickness which could smear the interference field of the object and reference beams and which could lead to deviations in the optical function of the replicated hologram from the master hologram.

In comparison with the methods based on index matching liquids, as known from the prior art, the use of an optical adhesive film can also be designed to be safer for the user. This is due to the fact that such an adhesive film generally does not contain very poisonous substances and is not volatile, and so no separate safety measures (e.g. gas extraction or isolation) are required.

Moreover, volatile index matching liquids generally cannot be recuperated post use. That is to say they either evaporate or do not have a required degree of purity, meaning that reuse is only possible after a complicated re-distillation. This increases the material outlay or the technological system outlay and makes the method more expensive. By contrast, the optical adhesive film can be reused for multiple applications. Advantageously, a single loop of adhesive film can run through the process, for example. By preference, a loop represents a closed arrangement of the optical adhesive film, in the case of which the same optical adhesive film is used multiple times for exposure purposes. In an alternative, for example, an optical adhesive film can also be supplied continuously to an exposure station from an unwinding roller provided. Should no more adhesive film be available on the unwinding roller, the latter can be filled or replaced. It can also be preferable that a used optical adhesive film is wound up again post exposure by means of a rewinding roll, in order to be reused or recycled. Consequently, the method according to the invention can advantageously be configured to save resources in various ways.

Moreover, the method according to the invention is very material-friendly, clean and leaves no residue on the process components such as the master element or the input coupling element. By preference, this is due to the relatively weak adhesive power of the optical adhesive film and due to the fact that the latter can be removed continuously or intermittently from the surfaces of the process components. In this way, fresh optical adhesive film can also be applied to the surfaces in either continuous or intermittent fashion. Hence, the optical adhesive film preferably does not represent a sticky, permanent process component on which dust or residue could accumulate. Residue on the exposed composite web is also avoided, and so the hologram produced can be integrated seamlessly in an end product-preferably without a further cleaning step. This improves the efficiency of the method, and unnecessary work steps are eliminated.

A further advantage of the method according to the invention lies in the fact that the light-sensitive composite web, or at least an outer layer thereof, can be configured both as a solid or as a non-solid. For example, the light-sensitive material can be solid and/or enclosed between solid carrier layers such as polycarbonate films. The solid carrier layers can be applied to the surface of a process component which can even be completely smooth (without a relief pattern). As a rule, it is difficult to bring two smooth solid surfaces into good optical contact with one another since the intermolecular forces acting between the surfaces are not strong enough to bring these into uninterrupted contact with one another, and the surfaces can even electrostatically repel one another. By virtue of temporarily bringing the optical adhesive film between the solid surfaces, it is possible to create sufficiently attractive electrostatic forces therebetween in order to ensure stable contact and no relative motion between the composite web and the adjacent component. This significantly improves the quality of the replication method.

Even if an outer layer of the light-sensitive composite web should comprise a non-solid, for example a semi-solid or resinous material, it can nevertheless be used together with the optical adhesive film. For example, a solid carrier layer of the composite web can be brought into contact with the optical adhesive film. In an alternative, the optical adhesive film is used to bring the non-solid surface into contact with a process component, and it is subsequently removed from the non-solid surface after the latter was fixed and/or cured. Thus, the optical adhesive film is versatile and suitable for a number of different embodiments of the light-sensitive composite web.

As evident from the aforementioned advantages, a method in which the optical adhesive film is applied between the light-sensitive composite web and the input coupling element solves the same technical problem as a method in which the optical adhesive film is applied between the light-sensitive composite web and the master element. In particular, the optical adhesive film improves the optical contact between exposed transparent components, through which the exposure light is guided. This reduces unwanted reflections, scattering or losses, and the quality of the reproduced hologram is improved. Therefore, the two methods are linked to one another so as to form a single general inventive concept.

It is also evident to a person skilled in the art that preferred features or advantages of embodiments of the method in which the optical adhesive film is applied to the master element likewise apply to embodiments of the method in which the optical adhesive film is applied to the input coupling element, and vice versa. Moreover, a combination of the methods is evidently particularly preferred. That is to say, if an input coupling element is used in the exposure process, then it is particularly preferable to introduce an optical adhesive film both temporarily between the master element and the light-sensitive composite web and between the input coupling element and the light-sensitive composite web. However, it can also be preferable to temporarily introduce an optical adhesive film only between an input coupling element and the light-sensitive composite web, for example, and not between a master element and the light-sensitive composite web. In such an embodiment, the light-sensitive composite web can consequently also be exposed while it is in direct contact with a surface of the master element, wherein the contact is not imparted by an optical adhesive film.

Within the meaning of the invention, an “application” preferably means that one process component (e.g. master element, input coupling element and/or light-sensitive composite web) is brought into indirect or direct contact with another one. For example, a protective layer and/or optical adhesive film can be present between the process components when a composite web is applied to a master element or input coupling element. Within the meaning of the invention, an “application” is also preferably used to indicate that one process component exerts a mechanical force on another one, e.g. by virtue of resting on the latter and weighing down on it (like in the case of an input coupling element resting on a light-sensitive composite web) or exerting a frictional force, like in the case of a rotating cylindrical master element which brings a light-sensitive composite web to move concurrently with the master element. The force transfer can also be in reverse, with the result that the light-sensitive composite web brings about a movement or rotation of the master element.

Within the meaning of the invention, a “process component” is preferably a stationary, movable or consumable component or material used in the exposure method. By preference, the process component is configured such that it interacts with the light during the exposure method, for example by a reflection, transmission or diffraction, in order to adjust the exposure method. For example, optical components, such as the master element or the input coupling element, represent a process component within the meaning of the invention, just like a light-sensitive composite web.

Within the meaning of the invention, the “surface” of a process component can relate to the surface of the process component that is brought into contact with another process component. By preference, the “surface” of a process component can also relate to its outermost layer, especially in the case of a process component with a layer structure. For example, the surface of the light-sensitive composite web can be an upper carrier film, while the surface of a master element can relate to an upper cover that serves to protect the master hologram.

Within the meaning of the invention, a “detachment” is a separation, preferably the separation of the process components, such that these are no longer in contact with one another, preferably neither in direct nor in indirect contact. By preference, a “detachment” consequently introduces an increasing air gap between the process components, for example when detaching the composite web from a master element or input coupling element.

“Optical contact” should preferably allow a beam path of light to pass between process components without experiencing substantial reflections or even total-internal reflection. Direct integrally joined contact between the process components is possible but not mandatory. For example, an optical adhesive film which imparts contact is provided for imparting optical contact between the master element and the composite web. However, there preferably is direct optical contact between the optical adhesive film and the adjacent process components. Should a gap be present between the surfaces of the optical adhesive film and the adjacent process component, it is preferably smaller than half a wavelength of the light such that no interference fields form at the interface between the surfaces. By preference, neither reflection (especially total-internal reflection) nor scattering occurs at the interface between the surfaces.

The optical contact between the light-sensitive composite web and a further process component (master element, input coupling element) is imparted by an optical adhesive film. By preference, this means that the light-sensitive composite web and the further component are in mechanical contact with the optical adhesive film. By preference, this means that the optical adhesive film adheres physically, chemically or electrostatically to a surface of the light-sensitive composite web or of the further component.

By preference, an “adherence” or “adhesion” of the optical adhesive film to the light-sensitive composite web and/or the further process component comprises the presence of attractive forces between the optical adhesive film and the relevant component. Should the optical adhesive film be introduced between two process components in order to impart optical contact therebetween, the attractive forces present between each process component and the optical adhesive film are preferably stronger than the attractive forces that would be present between the surfaces of the process components without the optical adhesive film. In other words: The process components preferably adhere more strongly to the optical adhesive film than to one another. Moreover, the adhesion is preferably sufficient to prevent movement between the process components between which the optical contact is imparted.

A “composite” within the meaning of the invention is preferably a multilayered material consisting of two or more different components having different physical properties, which are bonded to one another at an interface. Preferably, the bond between the individual components is constituted such that it is not separable by slight force influence and is therefore deemed to be permanent. By preference, the layers of the composite web must not be separated by a force of less than 10 N/cm, preferably of less than 50 N/cm, even more preferably of less than 100 N/cm. For example, the composite can consist of a material that is enclosed between two transparent carrier films. The light-sensitive composite can be provided with one or more protective films that are present during the exposure or removed prior to the exposure. In an alternative to that or in addition, the composite web can comprise a stack of layers that are each light-sensitive for different spectral ranges.

A “composite web” within the meaning of the invention is preferably a composite material having a length that is at least double, preferably at least five times, and even more preferably at least twenty times, its width. The thickness of the composite web is preferably set such that it has a certain flexibility, enabling it to be partly wound around a roller, for example. By preference, the composite web has a thickness of up to 1000 μm, preferably up to 500 μm, particularly preferably up to 100 μm. The composite web comprises a light-sensitive material. Preferably, the composite web encloses the light-sensitive material between two transparent carrier films having a refractive index similar to that of the light-sensitive material. Preferably, the refractive index of the carrier films and of the light-sensitive material is between 1.4 and 1.6. In some preferred embodiments, the light-sensitive composite web comprises a light-sensitive material on a single carrier film, with the result that one surface of the light-sensitive material is present uncovered. For example, the light-sensitive material can be a light-sensitive photopolymer or a dichromated gelatin with a preferred layer thickness of between 1-500 μm. The light-sensitive material can be light-sensitive or wavelength-selective for the entire visible spectrum.

Within the meaning of the invention, the “light sensitivity” preferably relates to the suitability of a material for holography. By preference, a material is considered suitable for holography if, in the event of exposure to sufficiently coherent light, the interference fields of the light can be stored in the material as microstructures. By preference, the suitability for holography is linked with the size of the arising microstructures. By preference, the arising microstructures are no larger than the light/dark structures of an interference field.

Within the meaning of the invention, “exposure” should preferably be understood to mean the targeted steering of electromagnetic beams, preferably in the wavelength range between 400 and 1600 nm, to an appropriately sensitive surface, preferably for the formation of a hologram. Different methods of exposing a hologram are known; these include transmissive or reflective techniques for producing volume holograms. Examples thereof will be explained in detail below within this document.

A “master element” is preferably a three-dimensional unit which comprises at least one master hologram in a form which ensures that a movement of the master element leads directly to a corresponding movement of the master hologram. A master element can also comprise a plurality of master holograms, for example 2, 3, 5, or more. By preference, the master element has a length and width approximately corresponding to those of the master hologram. It is preferred for the height of the master element to be at least double, preferably five times, and particularly preferably at least twenty times, the height of the master hologram.

The master element preferably comprises a substrate body, which either encloses or carries the at least one master hologram. In embodiments, the master element can comprise for example a transparent upper cover for protecting a master hologram present between the cover and the substrate body. By preference, the upper cover has a refractive index that has been chosen such that light is passed through it, the master hologram and the substrate body substantially without being diffracted. The upper cover can be for example a transparent film or a glass layer.

The master element can preferably have the shape of a parallelepipedal block, a plate, a pyramid, a prism or a cylinder. The substrate body can be shaped correspondingly.

By preference, the substrate body of the master elements can be formed from a material which is an optical plastic, preferably selected from the group: polymethylmethacrylate (PMMA), polycarbonate (PC), cycloolefin polymers (COP) and cycloolefin copolymers (COC), and/or is an optical glass, preferably selected from the group: borosilicate glass, quartz glass, B270, N-BK7, N-SF2, P-SF68, P-SK57Q1, P-SK58A and P-BK7.

Preferably, both the substrate body and a possible cover of the master element have a refractive index of between 1.4 and 1.6.

The selection of the material for the substrate body can depend on the desired exposure angle or refractive index. It can additionally be preferred for a substrate body to be colored in order for example to wavelength-selectively filter light in order to create a hologram with a specific wavelength. In this way, it is possible to use a broadband light source for the exposure of different master holograms.

It is preferred for the surface of the master element to comprise glass, PC, TAC or PMMA. The material of the surface can be present in the form of a film or plate for protecting the master hologram. However, the material of the surface can also be the material of the substrate body itself and have for example a parallelepipedal shape or cylindrical shape.

Whether an optical adhesive film is placed on a substrate or on a cover of a master element can depend on the direction from which the master hologram is intended to be exposed. In some cases, the optical adhesive film can be applied to a side or base of the master element. By preference, the relevant surface of the master element is smooth; in particular, this means that it does not comprise a relief pattern. By preference, the master hologram comprises a volume hologram. To replicate the volume hologram, the quality of the reproduction primarily depends on the optical contact, and not the mechanical contact, between the master hologram and the utilized light-sensitive material. Moreover, the optical adhesive film can more easily be applied and removed without leaving residue behind, e.g. in the depressions of a relief pattern, should the surface of the master element be smooth.

By preference, the “width” relates to a dimension in a horizontal plane transversely to a composite web direction of travel. By preference, the “length” relates to a dimension in a horizontal plane along a composite web direction of travel. By preference, the “height” relates to a dimension in a vertical plane that is orthogonal to the plane formed by the width and length.

A “substrate body” within the meaning of the invention is preferably a three-dimensional material block that carries or encloses the master hologram. Preferably, the substrate body is transparent. In some embodiments, the substrate body has a plurality of faces, including a flat surface that can be oriented horizontally. In some embodiments, the substrate body is prismatic, i.e. it has a constant cross section of any desired shape, e.g. square, polygonal, elliptical or circular. The ends of the substrate body that have the shape of the cross section can be referred to as the “base”. The elongate face of the substrate body located between the two ends can be referred to as “lateral face”. In some embodiments, the shape of an axially rotatable cylinder is preferred. Within the meaning of the invention, the form of a rotatable prismatic substrate body or master element, preferably of a cylinder, can also be referred to as a “roller”.

Within the meaning of the invention, the term “transparent” or “transparency” preferably relates to a property of a material whereby it is substantially transmissive to light. Preferably, a transparent material within the meaning of the invention is transmissive at least to part of the electromagnetic spectrum, preferably with a wavelength of between 300 nm-25 μm, particularly preferably between 400 nm-780 nm. Particularly preferably, a transparent material, for example a transparent substrate body, is transmissive to light in a wavelength range with which an exposure of the master holograms is effected. A transparent material can also be colored in such a way that it selects the light radiation of a specific wavelength.

A “master hologram” within the meaning of the invention is preferably a holographic optical element comprising at least one hologram to be replicated. The master hologram is designed for an optical function (e.g. diffraction, reflection, transmission and/or refraction) for one or a plurality of wavelengths. For this purpose, for example, multiple holograms, each of which e.g. diffracts light at one wavelength, and/or multiplex holograms, which diffract light at a plurality of wavelengths, can be present arranged as hologram stacks. The master hologram can be a diffractive optical element (DOE), for example. Diffractive optical elements (DOEs) use a surface relief profile with a microstructure for their optical function. In an alternative, the microstructure can also be present in the volume of the element, e.g. in the form of a local difference in the refractive index. The light transmitted by a DOE can be converted into almost any desired distribution by diffraction and subsequent propagation. This can involve an image, a logo, a text, a light refraction pattern or the like. By preference, the master hologram comprises a volume hologram.

The process for producing the master hologram can preferably be referred to as “hologram origination” or “hologram mastering”. The master hologram can be created by an analog or digital method. In one exemplary analog method, a first coherent beam, the object beam, is reflected from an object and onto a recording material, which is simultaneously subjected to a second coherent beam, the reference beam. The object beam and the reference beam interfere and create an interference pattern on or in the recording material. This interference pattern is recorded by light-sensitive material, and so after processing this gives rise to the shape of a surface relief pattern on a surface of the material or a spatially varying refractive index in the material, which is usually only a few micrometers thick. In order to view an image of the original object, the master hologram can be illuminated with light that is diffracted by the recorded surface relief pattern or refractive index pattern. This diffracted beam contains the image of the original object. The master hologram can subsequently be used as a new object when creating further copies with the same image.

The master hologram can preferably also be computer-generated. The microscopic gratings which generate the diffraction effects can be produced e.g. by laser interference lithography. In this technique, two or more coherent light beams are configured such that they interfere at the surface of a recording material. The positions of the light beams with respect to the recording material can be controlled by a computer. Depending on the intensity of the laser, the recording material can consist of almost any material. Other techniques such as electron beam lithography can likewise be used for the digital production of the master hologram. The master hologram can preferably comprise glass, silicon, quartz, UV lacquer, a photopolymer composite and/or a metal such as nickel.

Within the meaning of the invention, an “input coupling element” is preferably a three-dimensional block made of transparent material which has a refractive index and dimensions configured such that they direct the exposure beams to the master holograms and/or guide said exposure beams away from said master holograms. By preference, the input coupling element can have various optically accessible faces. By preference, at least one side face and a lower side of the input coupling element are optically accessible. In some embodiments, the input coupling element can have the shape of a parallelepipedal block, a (flat) plate, a pyramid or a prism. In some embodiments, the input coupling element is prismatic, i.e. it has a constant cross section of any desired shape, e.g. square, polygonal, elliptical or circular. The ends of the input coupling element that have the shape of the cross section can be referred to as the “base”. The elongate face of the input coupling element located between the two ends can be referred to as “lateral face”. In some embodiments, the shape of an axially rotatable cylinder is preferred. Within the meaning of the invention, the form of a rotatable prismatic input coupling element, preferably of a cylinder, can also be referred to as a “roller”.

By preference, the input coupling element can be formed from an optical plastic or optical glass, wherein preferred materials mentioned above in relation to the substrate body of the master element can be used in preferred embodiments.

It is preferred for the surface of the input coupling element to comprise glass, PC, TAC or PMMA. The material of the surface can be present in the form of a film or a plate in the case of a multi-layered input coupling element. However, the material of the surface can also be the material of a monolithic input coupling element and have for example a parallelepipedal shape or cylindrical shape.

In a preferred embodiment of the invention, the surface of the input coupling element comprises an antireflective coating. This can largely eliminate reflection losses at the surface of the input coupling element.

The input coupling element can be arranged in various alignments with respect to the master element, wherein the light-sensitive composite web is preferably positioned between the input coupling element and the master element during the exposure. If a parallelepipedal input coupling element and master element with top, bottom and side faces are assumed, then the input coupling element can for example be present arranged above the master element. In this case, it can be preferable for the composite web to be guided between a top side of the master element and a bottom side of the input coupling element. A reference beam can be directed obliquely downward to a side face of the input coupling element present as a block or parallelepiped above the master element. The reference beam is refracted by the input coupling element, and the refracted reference beam reaches the master hologram through the composite web. For example, the refraction caused by the input coupling element can be used to obtain an acute angle of incidence that is required for an edge-lit hologram. A master hologram can reflect the refractive reference beam such that an object beam passes through the composite web from the master hologram. The object beam and the reference beam interfere in the light-sensitive material of the composite web in order to create a reflection hologram. Optical losses or unwanted reflections at the interfaces can be effectively avoided by the provision of an optical adhesive film on both sides of the composite web.

In a preferred embodiment of the invention, the optical adhesive film and/or the light-sensitive composite web is applied to the surface of the master element and/or of the input coupling element by means of a lamination.

Within the meaning of the invention, a “lamination” is preferably a method for connecting two components, wherein the connection is preferably non-permanent. One of the two components preferably comprises a rigid, flat surface and is preferably securely attached. The other of the two components is preferably flexible and can travel during the lamination. The lamination is preferably configured such that the light-sensitive composite web and/or the optical adhesive film covers a rigid surface of preferably a master element and/or input coupling element all over, in such a way that no gaps, bubbles or folds are present. Optionally, the lamination is implemented by means of a lamination roller which is preferably able to exert a pressure. Lamination can be implemented at room temperature (20° C.). Optionally, the lamination roller can also be heated to a lamination temperature above room temperature, for example a temperature selected from a range of 20-200° C., preferably 40-100° C. The lamination (for example, a lamination pressure or a lamination temperature) is preferably designed such that a gap-free, but detachable (temporary) connection is established between the light-sensitive composite web and/or the optical adhesive film and a relevant surface (of a master element and/or input coupling element, for example).

In a preferred embodiment of the invention, the optical adhesive film and/or the light-sensitive composite web is applied to the surface of the master element and/or of the input coupling element by bringing a traveling light-sensitive composite web into contact with a partial circle of a curved surface. By preference, the curved surface is part of the lateral face of a rotatable cylinder, wherein the partial circle preferably has an aperture angle of between 1° and 45°, more preferably between 2° and 20°. By preference, the light-sensitive composite web and/or the optical adhesive film temporarily adopts the shape of the lateral face during the exposure.

In a preferred embodiment of the invention, the method comprises the step of detaching the optical adhesive film from the master element, the input coupling element and/or the light-sensitive composite web. By preference, detachment is implemented continuously or intermittently. In the case of a roll-to-roll method, the optical adhesive film can be moved continuously through an apparatus in synchronization with the composite web. If, by contrast, the composite web is kept stationary for each exposure step and is only moved following the complete exposure of a master hologram (e.g. if the master element is a plate rather than a roller), then the optical adhesive film is preferably also kept stationary during the exposure step and detached following the complete exposure of the master hologram. In a preferred embodiment of the invention, a refractive index difference between the surface of the master element and the optical adhesive film and/or between the optical adhesive film and a surface of the light-sensitive composite web is no more than 0.2, preferably no more than 0.1 and more preferably no more than 0.05.

By virtue of the refractive index of the optical adhesive film being set such that it is identical or comes very close to the refractive index of the adjacent process component, it is possible to obtain excellent optical contact without internal reflections at the interfaces. This can improve the quality of the reproduced hologram since losses and optical disturbances are minimized.

Likewise, in the case in which the optical adhesive film is introduced between the light-sensitive composite web and an input coupling element, the difference between the refractive index of the optical adhesive film and an adjacent surface of the input coupling element is preferably no more than 0.2, more preferably no more than 0.1 and more preferably no more than 0.05.

In a further preferred embodiment of the invention, a refractive index of the optical adhesive film is between the refractive index of the surface of the master element and the refractive index of a surface of the light-sensitive composite web. Should the optical adhesive film be arranged between the light-sensitive composite web and an input coupling element, the refractive index of the optical adhesive film is preferably between that of the light-sensitive composite web and that of the input coupling element. In this context, the term “between” preferably also includes the values of the refractive indices of the adjacent process components themselves. This arrangement allows a smooth or disturbance-free transition of light beams between the various process components, with minimal reflections and/or aberrations at interfaces.

As an illustrative example, the refractive indices can for example be chosen as set forth below, using a substrate body of a master element as a starting point.
substrate body (made of N-BK7): nₑ=1.519
adhesive layer: nₑ=1.51
master hologram (photopolymer layer): nₑ=1.500
master hologram (protective film): nₑ=1.485
optical adhesive film (adhesive layer/carrier layer/adhesive layer): nₑ=1.47/1.485/1.47
composite web (carrier film/photopolymer layer/carrier film) nₑ=1.48/1.50/1.48

In the example above, the light-sensitive composite web can for example comprise a carrier film made of triacetate (TAC), which has a refractive index of 1.48. Unless otherwise specified, the refractive indices specified in this document are measured pursuant to ISO 489.

If the light-sensitive composite web comprises photopolymers and one or more TAC carrier films, then the optical adhesive film preferably has a refractive index of 1.48+/−0.2, preferably +/−0.1, more preferably +/−0.05, such that the aforementioned values allow a particularly smooth optical transition.

If the light-sensitive composite web comprises photopolymers and a PC carrier film, for example, then the optical adhesive film can preferably have a refractive index of 1.58+/−0.2, preferably +/−0.1, more preferably +/−0.05, such that a particularly smooth optical transition is likewise ensured.

In a further example in which the light-sensitive composite web comprises a PC carrier film and is in contact with the optical adhesive film which in turn is in contact with a TAC protective layer of a master element, it can also be preferable for the refractive index of the optical adhesive film to be between that of PC and TAC, i.e. the optical adhesive film preferably has a refractive index between 1.48 and 1.58.

A person skilled in the art knows of materials which, using the present teaching as a starting point, allow a refractive index transition that is as continuous as possible between the master element/input coupling element and the adjacent surface of the light-sensitive composite web. For example, as one alternative the substrate body can comprise Borofloat-33, which has a refractive index of 1.48. The materials of the further layers can be selected so as to be matched to this index. In general, it is preferable for all of the aforementioned components (substrate body to optical adhesive film) that the respective refractive index is between 1.4 and 1.6.

In a preferred embodiment of the invention, the light-sensitive composite web comprises a carrier film and a light-sensitive material, wherein the light-sensitive material is present as a layer on the carrier film. By preference, one side of the light-sensitive material remains uncovered. In preferred embodiments, the light-sensitive material is soft and/or deformable, especially in liquid or resinous form. Thus, the light-sensitive material can adhere to a solid surface and optionally be deformed, for example for replicating a surface relief pattern.

By preference, the uncovered side of the light-sensitive material is brought into contact with the surface of the master element during the exposure. By preference, no optical adhesive film is inserted between the light-sensitive material and the master element. Instead, the optical adhesive film can be introduced between the side of the carrier film facing away from the master element and an input coupling element. By bringing the light-sensitive material into contact with the surface of the master element, it is possible to exploit a physical deformability of the light-sensitive material in order to obtain gap-free contact with the surface of the master element. For example, the light-sensitive composite web can be pressed onto the surface of the master element in order to eliminate air gaps. In an alternative to that or in addition, the light-sensitive material can have adhesive properties analogous to the properties of the optical adhesive film. This can suppress unwanted reflections at the interface between the light-sensitive material and the master element. This arrangement can have additional advantages should the master element comprise a surface relief that can be transferred into the light-sensitive composite web as a result of the contact. Optionally, it is subsequently possible to apply further layers, for example a second carrier film or a protective coating, to the exposed and preferably cured light-sensitive material in order to enclose the light-sensitive material.

In a further preferred embodiment of the invention, the optical adhesive film comprises at least one adhesive layer. The at least one adhesive layer preferably has a peel force vis-à-vis the surface of the master element and/or of the input coupling element and/or a surface of the light-sensitive composite web of less than 3 N/cm (newtons per centimeter), preferably of less than 1 N/cm. However, in preferred embodiments, the peel force of the adhesive layer of the optical adhesive film vis-à-vis the surface of the master element and/or of the input coupling element and/or a surface of the light-sensitive composite web is at least 0.01 N/cm, preferably at least 0.1 N/cm. It was found that the aforementioned parameters for the peel force represent an optimum between a simple, residue-free removal of the optical adhesive film from the respective component and the simultaneous elimination of an optical interface between the components. Moreover, it was established that these peel forces sufficiently suppress relative movements, for example vibrations, between the components. While the transparent state-of-the-art adhesives can contribute to improving the quality of the reconstruction of a hologram, the optical adhesive film of the present invention improves the quality of the replication. This is because it is sufficiently adhesive to reduce optical losses at the interface between the components; however, it can also be removed such that the composite web can be moved from a master element to a further process station.

By preference, the material and the configuration of the adhesive layer have been selected such that the latter adheres to, and is not repulsed from, the material of the composite web, of the master element and/or of the input coupling element, with which it should be brought into contact. Thus, by preference, the adhesive layer adheres to all transparent polymers and glasses, especially to the aforementioned preferred materials for a master element, input coupling element or a composite web. In addition to that or in an alternative, the adhesive layer preferably adheres to a solid and/or resinous light-sensitive material, particularly preferably a photopolymer. In particular, the optical adhesive film does not serve to facilitate the detachment of the composite web from the respective process component; instead, it serves to improve the optical contact. This can also include an additional improvement in mechanical or electrostatic contact.

For example, the peel force of the optical adhesive film or one of its layers can be measured according to a 180 degrees peel test. In preferred embodiments, the measurement is implemented pursuant to ASTM D903, in which six inches of an adhesive strip are applied to a clean substrate surface. The substrate is clamped. A free end of the adhesive strip is folded backward through 180 degrees and pulled with a force gauge. The force in newtons required to detach each centimeter of the adhesive strip from the substrate corresponds to the peel force.

The peel force of an adhesive material vis-à-vis a substrate surface preferably depends not only on the material composition of the adhesive material and of the substrate but also on the process conditions under which the adhesive material was applied to its carrier, if present, and to the substrate surface. For example, a stronger bond with a carrier layer can be obtained in the case of pressure-sensitive adhesive materials if a high pressure, temperature and/or additional crosslinking of the adhesive material on the carrier layer is applied during the application on the carrier layer. By preference, an additional adhesion promoter layer can be introduced in order to specifically increase the adhesion of the adhesive material on the carrier layer. This effect can be exploited in order firstly to improve the integrity of a multi-layer optical adhesive film and simultaneously keep peel forces of the multi-layer adhesive film low vis-à-vis process components such as a composite web, an input coupling element or a master element.

In contrast to the OCAs used in the finished products of the prior art to create permanent adhesion, the preferred peel force is low. This means that although the optical adhesive film adheres sufficiently to ensure optical contact during the exposure, it can easily be removed at the same time without tearing or leaving residue on the composite web or adjacent process components. Moreover, the optical adhesive film can be advantageously provided in very thin form. Great mechanical strength is not required to prevent damage or tearing during the process of detachment from the respective surface. Moreover, a comparatively low adhesive power or peel force of the optical adhesive film facilitates a reuse of the optical adhesive film, for example by the provision of a loop as explained above.

In a further preferred embodiment of the invention, the optical adhesive film comprises at least one adhesive layer, wherein the at least one adhesive layer has a Young's modulus of up to 50 MPa. For example, Young's modulus can be determined by a test in accordance to DIN EN ISO 725, ASTM D5026 and/or ASTM D882 or DIN EN 15870. That is to say, the optical adhesive film preferably has a certain degree of elasticity. This is particularly useful in order to wind the optical adhesive film around transport rollers and the surfaces of the optical components with which it is used. It is less likely for the sufficiently elastic optical adhesive film to be jammed, be damaged and/or torn during the transport as a result of the method. Moreover, it is possible to avoid plastic deformations that can lead to irregularities in the optical contact.

By preference, the adhesive layer has a transmission of at least 80%, wherein the transmission is preferably measured without Fresnel correction. By preference, this means that the measured transmission is reduced by the absolute value of the two Fresnel reflections at the front and back side of the material. The transmission without Fresnel reflections is preferably approx. 8% higher than with an uncorrected method. Alternatively, the transmission measurement can be implemented with p-polarized light at the Brewster angle, since there are no interface reflections for p-polarized light at the Brewster angle. By preference, the transmission relates to the transmissivity of a medium to light waves, without a change in wavelength. The percentage transmission is preferably the percentage of the intensity of the transmitted light in comparison with the light incident on the medium. For example, the transmission can be measured pursuant to DIN EN ISO 13468. The adhesive layer is therefore preferably transparent to light over the wavelength spectrum of 400-780 nm and has minimal light scattering. The adhesive layer is preferably colorless. A yellow tinge or gray appearance is also admissible, however. Such an adhesive layer can be used for a plurality of applications and should therefore be preferred over a color-filtering adhesive layer which is red, blue, green, etc.

Preferably, the adhesive layer has a haze of up to 2%. It is desirable that the degree of haze is minimized. This leads to a reduction in the losses of the light used for the exposure and to a reduction in unwanted reflections.

Within the meaning of the invention, the term “haze” preferably relates to transmission haze, measured pursuant to ASTM D1003. Haze preferably denotes a scattering of light during the passage through a transparent material, which may lead to the creation of additional disturbing interference fields and hence to additional but unwanted micro-optical structures in the replicated hologram. Haze can be an inherent property of the material, be a result of the forming process, a consequence of the surface structure or else the result of environmental factors such as surface abrasion.

By preference, the adhesive layer has over its width a brightness variation between crossed polarizers of up to 20%. This reduces the optical losses caused by the adhesive layer, and the quality of the replicated hologram is increased.

By preference, the adhesive layer furthermore comprises an adhesive material based on acryl, EVOH, rubber, silicone or mixtures thereof. Advantageously, a preferably low peel force, high transparency, sufficient elasticity and mechanical strength can be achieved by means of such materials in particular. Moreover, these materials can easily be shaped into adhesive films with suitable thicknesses. Methods for producing adhesive materials on the basis of the aforementioned materials are known to a person skilled in the art. Such methods are described in the specialist literature, for example in “Haftklebebänder, selbstklebende Folien und Etiketten” by Georg Krüger, ISBN 3446422811.

By preference, the adhesive material comprises at least one polymerizable resin, wherein the polymerizable resin is preferably based on acryl, EVOH, rubber, silicone or mixtures thereof, and at least one polymerizing agent. The polymerizing agent is preferably selected such that it triggers the polymerization of the monomers present in the polymerizable resin. The polymerizing agent preferably comprises a crosslinker and/or a crosslinking catalyst. Examples of monomers of a first type which are present in the polymerizable resin (for example acrylic resin) and can be polymerized by the polymerizing agent are (meth)acrylic ester monomers. The polymerizable resin can also comprise monomers of a second type which contains crosslinkable functional groups capable of reacting with the monomers of the first type. Examples of such crosslinkable functional groups include hydroxyl groups, carboxyl groups, glycidyl groups, isocyanate groups or a nitrogen-containing functional group and the like. By preference, the crosslinker and/or crosslinking catalyst is selected with regard to the crosslinkable functional groups present in the polymerizable resin.

The adhesive power of the composition can be adjusted by the addition of a suitable amount of a suitable crosslinker. A person skilled in the art is aware of suitable components and methods for producing an adhesive material having the preferred optical and mechanical properties.

In preferred embodiments, the adhesive layer has a thickness of 50 μm to 250 μm. The thickness can be adapted depending on the desired properties of the optical adhesive film. With a smaller thickness, it is for example possible to increase the transparency of the optical adhesive film while greater thicknesses can ensure an improved compensation of possible unevenness of the surfaces to be bonded and ensure increased mechanical strength. The aforementioned range of parameters was found to be particularly advantageous for a multiplicity of applications.

In preferred embodiments, the adhesive material comprises a crosslinker. Advantageously, the peel force required for detaching the optical adhesive film from the relevant surfaces can be reduced by a crosslinker. The crosslinker advantageously also prevented adhesive residue from remaining on the surfaces. A small amount of a crosslinker in an adhesive composition can increase the adhesive power of the adhesive up to a certain concentration. Above such a threshold concentration, for example 0.2%, an increase of the crosslinker can reduce the adhesive power. The proportion of crosslinker used can thus advantageously adjust the adhesive properties of the adhesive material.

A “crosslink” is preferably a bond or a short sequence of bonds which link one polymer chain to another. These connections can have the form of covalent or ionic bonds, and the polymers can be either synthetic polymers or natural polymers (such as proteins). A “crosslinker” is preferably an additive that promotes the formation of such crosslinks between the polymers present in the adhesive material.

Examples of crosslinkers include an isocyanate crosslinker, an epoxy crosslinker, an aziridine crosslinker, a metal chelate crosslinker or else a modified silane such as amino-bis-silane. As an example, a silane compound can be used as a crosslinker for acrylic resin.

By preference, a crosslinker is present in the adhesive material with a concentration of at least 0.1% by weight, preferably at least 0.2% by weight, particularly preferably 0.2-0.9% by weight. For the aforementioned concentrations, it was possible to achieve preferred peel forces of the optical adhesive film within a preferred range of 0.3-1.6 N/cm on different surfaces. These preferred crosslinker concentrations are particularly advantageous for an acrylate-based crosslinker. However, the preferred concentration of a crosslinker may depend on its crosslinking activity, the base material or the surface, as will be explained in detail hereinafter in this document.

In a further preferred embodiment of the invention, the optical adhesive film has a single-layer layer structure, wherein the layer structure comprises exactly one adhesive layer. The exactly one adhesive layer is preferably adhesive on both sides in order to impart optical contact. In this way, the optical adhesive film can be kept particularly thin, and possible optical interfaces within the optical adhesive film can be avoided. In the case of a single-layer layer structure, the optical adhesive film preferably has a tensile strength of at least 1 MPa, more preferably at least 2 MPa. By preference, the tensile strength is determined by a test method pursuant to ASTM D882 or DIN EN ISO 725. On the one hand, such an optical adhesive film can be kept very thin and transparent while, on the other hand, it has sufficient strength for various processes such as transport, application and/or lamination and can be removed without residue without the risk of damage. In a further preferred embodiment of the invention, the optical adhesive film comprises at least one carrier layer. Such an optical adhesive film has a multi-layer structure, wherein the carrier layer is coated with an adhesive layer at least on one side. The carrier layer is preferably not adhesive. In some embodiments, the carrier layer can be coated with an adhesive layer on one side only.

In a further preferred embodiment of the invention, the optical adhesive film comprises two adhesive layers, wherein each adhesive layer is preferably present in a manner applied directly to the carrier layer. It is particularly preferable for the carrier layer to be coated with an adhesive layer on both sides such that the optical adhesive film comprises three layers. Such an optical adhesive film can adhere to two surfaces simultaneously, whereby particularly good optical contact can be imparted, and a risk of air gaps or even unwanted reflections is reduced. In the case of a multi-layer (e.g. two-layer and/or three-layer) optical adhesive film, it is preferable that one or all adhesive layers have a tensile strength of at least 1 MPa, preferably of up to 2 MPa. This ensures a sufficient force transfer, and so shearing forces within the multi-layer structure do not lead to relative movements between the layers.

In a further preferred embodiment of the invention, the at least one adhesive layer is present in a manner applied directly to the carrier layer. By preference, the peel force of the adhesive layer vis-à-vis the carrier layer is greater than the peel force of the adhesive layer vis-à-vis the surface of the master element and/or of the input coupling element and/or of a surface of the light-sensitive composite web and/or of a protective film. This ensures that the adhesive layer stays adhered to the carrier layer during the entire method, and this avoids adhesive residue being left on process components.

The different peel forces of the adhesive layer vis-à-vis a carrier layer of the adhesive film or surface of process components (e.g. of a master element, of an input coupling element and/or of a composite web) can preferably be influenced by the selection of materials and/or process conditions at which the adhesive layer can be applied to a carrier layer. In preferred embodiments, the carrier layer is prepared by the application of an adhesion promoter (primer) to the side to which the adhesive layer is applied. In this way, the adhesive material can be applied to the carrier film and, in addition to the crosslinking of the adhesive material, it is also possible to establish a bond to a primer layer of the carrier film. As a result, the adhesive layer adheres more securely to the carrier layer than to a material laminated to the adhesive layer post crosslinking, even if this latter material consists of the same material as the carrier film.

In a further preferred embodiment of the invention, the surface of the carrier film intended to be coated with the adhesive layer is treated prior to coating, for example by plasma treatment or a corona treatment. Advantageously, such a surface treatment can also increase the adhesion between the carrier film and the adhesive layer.

In further preferred embodiments of the invention, the process conditions under which the adhesive layer is applied to the carrier layer are selected such that the adhesion of the adhesive layer to the carrier layer is increased. By preference, the temporary application of the optical adhesive film to the surface of the master or input coupling element is implemented under different process conditions, which allow for a lower peel force onto the surface of the process components. In this way, the effect of process conditions such as pressure, temperature and light can be utilized to preserve the integrity of a multi-layer optical adhesive film during its use.

By preference, the carrier layer has a tensile strength of at least 5 MPa. Such a carrier layer is particularly suitable as a stabilizer of the optical adhesive film and can be pulled with a greater force or be exposed to a greater frictional force without tearing. The tear resistance and hence the process capability of the optical adhesive film as webware can be reliably increased with such a carrier layer in a multilayer structure, whereby the risk of leaving residue on the relevant surfaces is significantly minimized. This allows for particularly reliable elimination of air gaps at the interface between the relevant surface and the optical adhesive film and improved optical contact.

By preference, the carrier layer—in a manner analogous to the at least one adhesive layer—has a transmission of at least 80%, wherein the transmission is preferably measured without Fresnel correction. The optical adhesive film can be transparent to light—especially in a wavelength range of 400-780 nm—and can exhibit minimal light scattering. It can also be preferable that the carrier layer has a haze of up to 1.5% in order to reduce light losses and wanted reflections. In particular, it is preferable that the carrier layer has a brightness variation between crossed polarizers of up to 30% over a width of the carrier layer in order to reduce the optical losses caused by the carrier layer.

By preference, the carrier layer comprises one or more of the following materials: polycarbonate (PC), polyethylene terephthalate (PET), polybutylene terephthalate, polyethylene, polypropylene, cellulose acetate, triacetate (TAC), cellulose hydrate, cellulose nitrate, cycloolefin polymers, polystyrene, polyepoxides, polysulfone, cellulose triacetate (CTA), polyamide, polymethylmethacrylate, polyvinylchloride, polyvinylbutyral, polydicyclopentadiene or mixtures thereof. Particularly preferably, the carrier layer comprises polycarbonate (PC), polyethylene terephthalate (PET), cellulose acetate, triacetate (TAC), polymethylmethacrylate or mixtures thereof.

The thickness of the carrier layer is preferably 6 μm to 100 μm. It was established that a thickness of at least 6 μm can offer the preferred tensile strength of at least 5 MPa for a multiplicity of materials while being highly transparent at the same time. The use of thinner carrier layers also ensures a thinner optical adhesive film overall. By contrast, the carrier film is even more tear resistant at greater thicknesses. Furthermore, particularly high transmission and low haze can be ensured up to a thickness of approximately 100 μm. Thus, the aforementioned range of parameters was found to be particularly advantageous for a multiplicity of applications.

In a further preferred embodiment of the invention, the optical adhesive film is provided with at least one protective film. By preference, the at least one protective film is removed prior to the step of temporary application of the optical adhesive film between the light-sensitive composite web and the surface of the master element. The protective film can protect the surface quality of the optical adhesive layer and maintain the smoothness and low haze of the latter. Moreover, the protective film protects the adhesive layer from particles possibly present in the replication process, and allows for the supply of the optical adhesive film in the form of rolls. It can also facilitate handling of the optical adhesive layer, especially during rolling, unrolling and transportation.

By preference, the protective film comprises one or more of the following materials: polycarbonate (PC), polyethylene terephthalate (PET), polybutylene terephthalate, polyethylene, polypropylene, cellulose acetate, triacetate (TAC), cellulose hydrate, cellulose nitrate, cycloolefin polymers, polystyrene, polyepoxides, polysulfone, cellulose triacetate (CTA), polyamide, polymethylmethacrylate, polyvinylchloride, polyvinylbutyral, polydicyclopentadiene, silicone paper or mixtures thereof. Particularly preferably, the protective film comprises polyethylene, polypropylene, silicone paper or mixtures thereof. The thickness of the protective film is preferably 10 μm to 50 μm.

In a further preferred embodiment of the invention, the at least one protective film is present directly on the at least one adhesive layer. By preference, the peel force required to remove the protective film from the adhesive layer is no more than 0.2 N/cm, particularly preferably no more than 0.1 N/cm.

In a further preferred embodiment of the invention, the optical adhesive film is provided with protective films on both sides. It can be preferable that only one or both protective films are removed prior to exposure. For example, it can be preferable that the protective film is removed from the side facing the master element and/or input coupling element.

It is preferable to remove the protective films from both sides of the optical adhesive film such that the adhesion properties of the optical adhesive film can contribute to improving the optical contact on both its interfaces with the adjacent process component. This improves the optical contact between the light-sensitive composite web and the input coupling element and/or master element.

In a further preferred embodiment of the invention, the optical adhesive film is temporarily applied between the light-sensitive composite web and the surface of the master element or of the input coupling element by means of at least one roller. The at least one roller is preferably selected from the group comprising: unwinding roller, transport roller, rewinding roller and/or lamination roller. For example, the optical adhesive film can circulate between two transport rollers that are arranged such that the path of the optical adhesive film comes into contact with the surface of a master element. In an alternative, the optical adhesive film can travel between an unwinding roller and a rewinding roller such that its path comes into contact with the surface of a master element.

In the case of a rotatable master element, the master element can be brought into a path of the optical adhesive film between an unwinding roller and a rewinding roller such that the optical adhesive film comes into contact with a part of the surface of the master element. In this case, the optical adhesive film (and the composite web) preferably temporarily assume the shape of a region of a lateral face of the master element. In the process, the optical adhesive film is preferably guided over the rotating master element and a speed of the optical adhesive film, of the composite web and of the master element are preferably synchronized with one another. Such an arrangement is particularly advantageous within the scope of a roll-to-roll hologram replication method, wherein the rotational speed of the various rollers can be set. Such a method is fast, economical and preferably suitable for the continuous mass production of HOEs.

In the event of a stationary, parallelepipedal master element, a lamination roller can roll over a stretched optical adhesive film and, for example, bring the latter into contact with the flat top side of a master element. Appropriate application of pressure allows air gaps to be removed and a particularly gap-free application to be attained.

In a further preferred embodiment of the invention, the optical adhesive film is introduced between the light-sensitive composite web and the surface of the master element by means of an input coupling element during the exposure step. By preference, a second optical adhesive film is introduced between the light-sensitive composite web and the input coupling element during the exposure, for example as shown in FIGS. 5, 6 and 8.

In a further preferred embodiment of the invention, the surface of the master element and/or the surface of the input coupling element is curved, wherein, by preference, the master element and/or the input coupling element is configured as an axially rotatable cylinder or roller.

Should the surface of the master element and/or input coupling element be curved, like in the case of a cylinder, the optical adhesive film adheres preferably temporarily to the surface of the master element, for example to the lateral face of a cylindrical master element, and/or input coupling element, over a comparatively short length. By preference, the optical adhesive film temporarily adheres over a length of between 1 mm and 20 mm, particularly preferably between 2 mm and 10 mm. This length can depend on the radius of the cross section of the cylinder. The region of adhesive and optical contact between the optical adhesive film and the master and/or input coupling element can also be measured in the form of the aperture angle of the cross section of the cylinder, over the arc length of which the optical adhesive film is applied. By preference, this angle is between 1° and 45°, more preferably between 2° and 20°. In the case of such a length and/or aperture angle, the risk of the optical adhesive film tearing is significantly reduced, and air gaps are sufficiently eliminated. A particularly little force is required to move the optical adhesive film by way of a continuous displacement, including the continuous detachment of the adhesive film from the curved surface.

In a further preferred embodiment of the invention, the steps of the method are controlled by a control unit. By preference, the control unit controls the transport speed of the optical adhesive film and of the light-sensitive composite web such that these are synchronized with one another during the exposure.

By preference, the term “control unit” relates to any desired computer unit having a processor, a processor chip, a microprocessor or a microcontroller allowing automated control of the components of the apparatus, e.g. a rotational speed of an unwinding roller, rewinding roller, lamination roller, transport roller, the movements/rotation of a master element, the movements/rotation of an input coupling element, a lamination temperature, a lamination pressure, an orientation and/or scanning speed of a light source, a wavelength of the light source, a fixation intensity, etc. The components of the control unit can be configured conventionally or on an individual basis for the respective implementation. By preference, the control unit comprises a processor, a memory and a computer code (software/firmware) for controlling the components of the apparatus.

The control unit can also comprise a programmable printed circuit board, a microcontroller or any other apparatus for receiving and processing data signals from the components of the device, for example from sensors in relation to the identity or the type of a master element, and other relevant sensor-based information. The control unit preferably furthermore comprises a computer-usable or computer-readable medium, such as a hard disk, a random access memory (RAM), a read only memory (ROM), a flash memory, etc., on which computer software or a code is installed. The computer code or the software for controlling the components of the device can be written in any desired programming language or model-based development environment, such as e.g. C/C++, C#, Objective-C, Java, Basic/VisualBasic, MATLAB, Python, Simulink, StateFlow, Lab View or Assembler, without being restricted thereto.

The phrase “the control unit is configured to” carry out a specific method step, e.g. the exposure of a master element at a specific angle by virtue of modifying the speed of one or more drive motors, may comprise customer-specific or standard software which is installed on the control unit and which initiates and controls these operational steps.

The exposure for replicating a master hologram by means of the method according to the invention can be implemented on the basis of various techniques. Hologram replication methods can be divided into relief holograms and volume holograms.

Relief holograms are formed by physical contact between a deformable sensitive layer and a master hologram such that the diffraction pattern of the master hologram is impressed in the sensitive layer.

A volume hologram is written into a sensitive layer, preferably by the interference of two light beams (a so-called reference beam and an object beam). By preference, a volume hologram is written into the composite web. By preference, this can be implemented by transmission or reflection technology. A sequence of Bragg planes preferably arises as a result of the interference of object and reference beams within the hologram volume. Consequently, a volume hologram preferably has a non-negligible extent in the propagation direction of the light beams, with the Bragg condition applying in the case of the reconstruction at a volume hologram. It is for this reason that volume holograms have a wavelength and/or angle selectivity. The capability of volume holograms to store a plurality of images at the same time inter alia allows the production of colored holograms or white holograms. Light sources emitting in the three primary colors of blue, green and red can be used for the recording of the holograms. By preference, the three beams illuminate part of the composite web simultaneously. Following the exposure, three holograms are stored in the volume hologram at the same time. The reproduction of the color hologram can exploit the fact that each partial hologram can only be reconstructed by the color with which it was recorded. Consequently, the three reconstructed color excerpts superimpose to form the colored, faithful image provided the color components are weighted correctly.

Reflection holograms are reflective holograms which reflect light incident from the light source and consequently act like a mirror. An incidence direction of the reference beam (preferably a light beam incident from the light source) and the object (the master hologram in this case) are preferably arranged on opposite sides of the composite web. A reference beam passes through the composite web and is subsequently reflected back into the light-sensitive layer of the composite web by the master hologram. Consequently, the reference beam and the object beam superimpose in the light-sensitive layer of the composite web in different beam directions in order to create the replicated hologram. By preference, the master hologram can be applied to a surface of the master element or be present in a manner integrated in the substrate body.

A light source for exposing a reflection hologram can be arranged such that the reference beam is incident on the composite web at a desired direction, preferably at a direction that is desired during the subsequent reconstruction. In a preferred embodiment, the light source is oriented in relation to the master element in such a way that the composite web is situated between the light source and the master element. For example, the light source can be aligned above the master element, in such a way that the reference beam is incident downwardly on the composite web in a predetermined direction. The angle at which the reference beam is incident on the master hologram can be set by way of a transparent input coupling element that diffracts the light at a desired angle. By preference, at least some of the reference beam is reflected back into the composite web as an object beam by the master element. Thus, the reference beam and the object beam enter the photopolymer composite from opposite sides and interfere in the light-sensitive layer of the latter in order to replicate the hologram.

Transmission holograms are transmissive holograms, wherein the light from a light source is passed and diffracted by the latter. An incidence direction of the reference beam (preferably a light beam incident from the light source) and the object (the master hologram in this case) can preferably be present in a manner arranged on the same side of the composite web. An incident beam passes through the master hologram and is separated into an (undiffracted) reference beam and an object beam. Consequently, the reference beam and the object beam superimpose in the light-sensitive layer of the composite web with the same beam direction in order to create the replicated hologram.

In a transmission hologram, it can be preferable to arrange the light source in such a way that the composite web can be exposed from the same side by a reference beam and by an object beam. By preference, the light source is oriented in such a way in relation to the master element that a light beam initially passes through the master element and the master hologram before it reaches the composite web. By preference, the light source can be arranged in such a way that light passes through a transparent master element from a side face. By preference, the light source can also be arranged in such a way that light is incident on the composite web through an upper and/or lower surface of the master element. By preference, the incident light beam is refracted in such a way by the master element that a reference beam and an object beam are created, wherein the object beam preferably corresponds to the component of the light diffracted by the master hologram. By preference, the object beam interferes with the undiffracted reference beam in the composite web in order to replicate the hologram.

In preferred embodiments of the invention, one or more master elements can be used to expose the composite web in order to replicate a transmission hologram therein. By preference, the replicated transmission hologram can be designed such that it is edge lit, and so the holographic image representation can be reconstructed by light from a substantially lateral direction. The replicated transmission hologram can also be configured such that it is illuminated from behind, and so the holographic image representation can be reconstructed by light incident in a manner substantially from the back to the front. It can also be preferable for one or more master elements to be used to expose the composite web and replicate a reflection hologram therein. It can also be desirable for the replicated reflection hologram to be edge lit. For example, such a hologram can be used in a glass pane, at the edges of which light sources are arranged in concealed fashion. The replicated reflection hologram can also be configured such that it is illuminated from the front. Advantageously, such a hologram can create a holographic image representation when illuminated by ambient light and observed relatively orthogonally at eye level. A plurality of such holograms can also be used in a glass pane, for example in the manner as disclosed in WO2020157312A1, in order to create a holographic image representation when observed orthogonally by virtue of light from concealed light sources being reflected along a predetermined path. It can also be advantageous to use one or more master elements to expose the composite web in order to create a hologram that comprises both a reflection hologram and a transmission hologram.

The process components can be arranged in various ways in order to create high-quality reflection and transmission holograms as desired. The optical adhesive film thus is versatile. Various techniques for exposing the composite web with a master element and optionally an input coupling element using different reference beam angles, and for creating different types of holograms, are explained by way of example below and in the detailed description on the basis of the drawings. The techniques can be combined with one another and with further embodiments of the method. An important advantage consists in the fact that an optical adhesive film according to the invention, in the various setups for replicating a hologram, ensures virtually perfect optical contact between the composite web and optical components such as a master element and/or input coupling element.

In a preferred embodiment of the invention, an optical adhesive film is introduced between a part of a lateral face of a cylindrical master element and a light-sensitive composite web. It can be preferable that no input coupling element is used during the exposure. In a preferred embodiment, a cylindrical input coupling element is used in combination with the cylindrical master element in a roll-to-roll method for the exposure. By preference, the master element and the input coupling element are mounted in rotatable fashion, with their rotation preferably being synchronized. The optical adhesive film and the light-sensitive composite web can run synchronously between the master element and the input coupling element. It is further preferable for a second optical adhesive film to be introduced between the light-sensitive composite web and the input coupling element such that an arrangement is formed from the following: cylindrical input coupling element/second optical adhesive film/light-sensitive composite web/first optical adhesive film/cylindrical master element. Such an arrangement can be exposed from a lateral face or base of the input coupling element such that a reference beam is refracted toward the master hologram. For example, such an exposure method can be suitable for the production of a reflection hologram. In an alternative, the exposure can also be implemented from a lateral face or base of the master element, for example, in order to create a transmission hologram. By virtue of both the master element and the input coupling element being configured as rotatable cylinders or rollers, the exposure method can be implemented quickly and continuously.

In a further preferred embodiment of the invention, a master element, but no input coupling element, is used during the exposure, wherein the master element has a flat surface and preferably is in the form of a parallelepiped or plate. By preference, an optical adhesive film is applied to the flat surface of the master element, for example by lamination using a lamination roller. By preference, the light-sensitive composite web is applied to the optical adhesive film, for example by lamination by way of the same or a further lamination roller. The lamination ensures good optical contact between the light-sensitive composite web and the surface of the master element. In comparison with arc-shaped contacting by way of a circular segment of a cylindrical master element, such an arrangement can offer a greater contact area. Therefore, such an arrangement can be advantageous for the production of batches in which for example a plurality of holograms are replicated by a plate-shaped master element.

In a further preferred embodiment of the invention, both a master element and an input coupling element are used during the exposure, wherein preferably only one of the master element and input coupling element is cylindrical. The non-cylindrical component can preferably have a flat surface and for example be in the form of a parallelepiped or plate. In such an embodiment, the cylindrical component can be used to laminate the optical adhesive film and/or the light-sensitive composite web on the flat surface of the master element or of the input coupling element.

As a simple example, the master element can have the shape of a parallelepiped. A first optical adhesive film can be applied to the upper flat surface of the master element, preferably by lamination. A light-sensitive composite web can be applied to the top side of the first optical adhesive film, preferably likewise by lamination. Further, a second optical adhesive film can be applied to the top side of the light-sensitive composite web, preferably by lamination. A cylindrical input coupling element—preferably used for laminating one or more of the aforementioned layers—is arranged above the second optical adhesive film such that optical contact is established between the lateral face of the input coupling element and all aforementioned process components up to and including the master element.

For example, exposure can be implemented by virtue of a reference beam being directed to the lateral face or the base of the input coupling element. In this case, the reference beam is refracted in such a way within the input coupling element that it emerges along the optical contact line and is reflected by a master hologram in the master element. In an alternative, the exposure can also be implemented from the master element, wherein the light is then guided away from the composite web through the input coupling element. In a further example, the functions of the parallelepipedal component and of the cylindrical component can be interchanged, i.e. the input coupling element can be parallelepipedal while the master element is shaped to be cylindrical.

In a further preferred embodiment of the invention, both a master element and an input coupling element are used during the exposure, wherein, by preference, both the master element and the input coupling element have a flat surface and are preferably present in the form of a parallelepiped, a block, a plate or a pyramid. In a preferred embodiment of the invention, the exposure process is carried out using a block-shaped master element, a first optical adhesive film, a light-sensitive composite web, a second optical adhesive film and a block-shaped input coupling element, which are in optical contact with one another in the sequence specified. The input coupling element is preferably also in optical contact with the master element, imparted through intermediate layers (first optical adhesive film, light-sensitive composite web, second optical adhesive film). By preference, the intermediate layers are applied to the respective surface of the master element or input coupling element by lamination, for example with the aid of a separate lamination roller.

### DETAILED DESCRIPTION

The invention will be explained in more detail below by means of examples and figures, without being limited thereto.

### BRIEF DESCRIPTION OF THE FIGURES

FIG. 1 is a schematic illustration of a single-layer optical adhesive film with protective films provided on both sides.

FIG. 2 is a schematic illustration of a three-layer optical adhesive film, comprising a carrier layer and two adhesive layers, with protective films provided on both sides.

FIG. 3 shows, by way of example, the peel force of preferred adhesive layers with different crosslinker concentrations for different surface materials.

FIG. 4 schematically shows a preferred arrangement for replicating a hologram, in which an optical adhesive film is introduced between a cylindrical master element and a light-sensitive composite web.

FIG. 5 schematically shows a preferred arrangement for replicating a hologram by means of a cylindrical master element and cylindrical input coupling element, in which a respective optical adhesive film is introduced both between the master element and the light-sensitive composite web and between the input coupling element and the light-sensitive composite web.

FIG. 6 schematically shows a preferred arrangement for replicating a hologram by means of a parallelepipedal master element and cylindrical input coupling element, in which a respective optical adhesive film is introduced both between the master element and the light-sensitive composite web and between the input coupling element and the light-sensitive composite web.

FIG. 7 schematically shows a preferred arrangement for replicating a hologram by means of a parallelepipedal master element without input coupling element, in which an optical adhesive film is introduced between the master element and the light-sensitive composite web.

FIG. 8 schematically shows a preferred arrangement for replicating a hologram by means of a parallelepipedal master element and parallelepipedal input coupling element, in which a respective optical adhesive film is introduced both between the master element and the light-sensitive composite web and between the input coupling element and the light-sensitive composite web.

FIG. 9 schematically shows a preferred arrangement for replicating a reflection hologram by means of a cylindrical master element by exposure on a lateral face, in which an optical adhesive film is introduced between the master element and the light-sensitive composite web.

FIG. 10 schematically shows an arrangement for replicating an edge-lit hologram by means of a cylindrical master element by exposure on a base, in which an optical adhesive film is introduced between the master element and the light-sensitive composite web.

FIG. 11 schematically shows an arrangement for replicating a plurality of holograms integrated in a plate-shaped master element, and a cylindrical input coupling element, wherein an optical adhesive film is introduced between the input coupling element and the composite web.

FIG. 11A is a schematic illustration of the application of the light-sensitive composite web to the surface of the master element.

FIG. 11B is a schematic illustration of the application of the optical adhesive film between the cylindrical input coupling element and the light-sensitive composite web applied to the master element, in order to establish optical contact between the input coupling element and the light-sensitive composite web.

FIG. 11C is a schematic illustration of the detachment of the input coupling element from the exposed composite web.

### DETAILED DESCRIPTION OF THE FIGURES

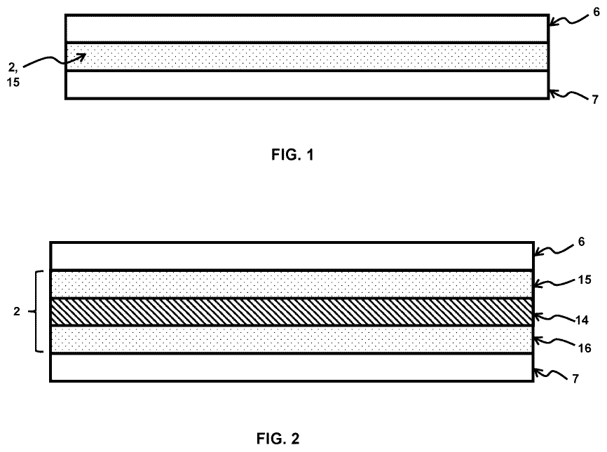

FIG. 1 shows a single-layer optical adhesive layer 2 for use in a method according to the invention. The optical adhesive layer 2 comprises exactly one adhesive layer 15. The adhesive layer 15 is provided with protective films 6 and 7 on both sides. In this embodiment of the optical adhesive film, it is preferable for the material of the adhesive layer 15 to be a weakly adhering adhesive. By preference, such an adhesive can be pulled from the surface of a relevant process component with a peel force of no more than 3 N/cm, preferably 1 N/cm. It is preferable for the tensile strength of the adhesive layer 15 to be at least 1 MPa, preferably at least 2 MPa, and for the single-layer optical adhesive film 2 to have a Young's modulus of less than 50 MPa. On the one hand, such an optical adhesive film 2 can be kept very thin and transparent while, on the other hand, it has sufficient mechanical strength and elasticity for various processes such as transport, application and/or lamination and can be removed without residue without the risk of damage.

The thickness of the single-layer optical adhesive film 2 is preferably between 50 μm and 250 μm such that all possible unevenness or all possible gaps between the light-sensitive composite web and the surface of the relevant process component are reliably filled in the region of the optical contact, in order to enable optimal exposure. The refractive index of the single-layer adhesive film 2 is preferably close to that of the adjacent layer of the light-sensitive composite web and/or of the adjacent layer or surface of the relevant process component.

FIG. 2 shows a three-layer optical adhesive film having a carrier layer 14 that is coated with a first adhesive layer 15 on a first side and with a second adhesive layer 16 on an opposite side. Together, these three layers form the optical adhesive film 2. The adhesive layers 15 and 16 preferably have analogous properties to those of the single-layer optical adhesive film from FIG. 1. However, it can be preferable that the adhesive material used in these layers is more adhesive than the adhesive material of the single-layer optical adhesive film. Moreover, these adhesive layers can have a lower tensile strength of up to 1 MPa.

By preference, the adhesive materials in the adhesive layers 15 and 16 of these embodiments require a greater peel force to be pulled off the carrier layer 14 than to be pulled off the surface of the relevant process component and/or the light-sensitive composite web 1.

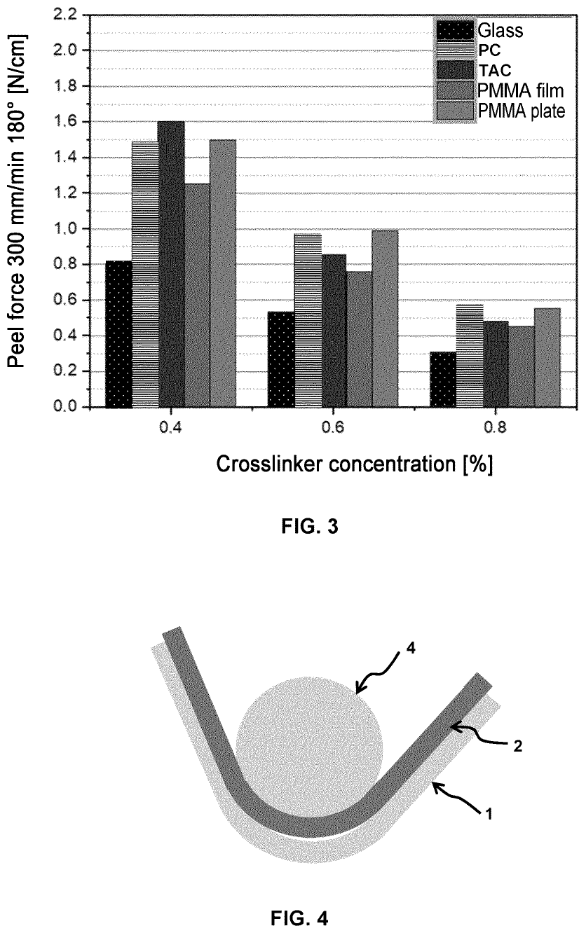

It can be preferable for the adhesive material used in the adhesive layers 15, 16 in FIGS. 1 and 2 to comprise a crosslinker. FIG. 3 shows the results of an investigation into the effect of a crosslinker on the adhesive power of an adhesive material. The examined adhesive material was produced on the basis of acrylate. However, similar results were also obtained with adhesive materials based on silicone or rubber. The adhesive layers 15 were produced with different concentrations of crosslinker. The adhesive layers 15 were applied to surfaces made of different materials such as glass, PC, TAC and PMMA, and were subsequently pulled off the corresponding surfaces at an angle of 180° at a speed of 300 mm/min. The peel force required to detach the adhesive layers from the corresponding surfaces was measured per centimeter of the adhesive layers.

The results show that an elevated concentration of crosslinker reduces the peel force required to detach the adhesive layers from the various surfaces. For example, in order to be removed from a polycarbonate (PC) surface, the adhesive layer 15 required a peel force of approximately 1.5 N/cm for a crosslinker concentration of 0.4%. This is slightly higher than the preferred maximum peel force of 1 N/cm for a weakly adhering adhesive, as is preferred for use in the single-layer optical adhesive film. However, the peel force can be reduced to less than 1 N/cm, for example, by virtue of increasing the crosslinker concentration to 0.6%.

The low peel forces exhibited by the exemplary adhesive layers are excellently suitable for the temporary application and residue-free removal of an optical adhesive film for improving optical contact between different process components.

According to the invention, the optical adhesive film 2 can be used in a multiplicity of arrangements to optimize the optical contact between various elements in an exposure method. FIGS. 4-8 are merely illustrative examples of the application of the optical adhesive film 2 according to the invention.

FIG. 4 shows the use of an optical adhesive film 2 between a cylindrical master element 4 and a light-sensitive composite web 1. The master element 4, which is preferably rotatably mounted, can preferably comprise a master hologram on its lateral face. The light-sensitive composite web 1 is guided over a portion of the lateral face on a bottom side of the master element 4, wherein a region of the composite web 1 to be exposed temporarily adopts, at least in regions, the shape of a lateral face of the master element 4 and is guided over the rotating master element 4 in a manner moving along with the lateral face. During the exposure, an optical adhesive film 2 is introduced between the composite web 1 and the circumference of the lateral face of the master element 4. In the region of the optical contact, the optical adhesive film 2 is present substantially parallel to the light-sensitive composite web 1, with its movement being synchronized with the movement of the light-sensitive composite web 1.

In this arrangement, the light can be directed to the light-sensitive composite web, for example from below, in order to form a reflection hologram. For such an exposure, the master element 4 can be configured to be transparent or else opaque, preferably apart from a transparent covering layer that protects the master hologram. The reference beam can travel, substantially without being refracted, through the light-sensitive composite web 1, the optical adhesive film 2 and the transparent cover before it is reflected by the master hologram. The reference beam and the object beam superimpose in the light-sensitive layer of the composite web in different beam directions in order to create the replicated hologram.

The optical adhesive film 2 advantageously prevents unwanted reflections and/or light losses at the interfaces between the optical adhesive film 2 and the light-sensitive composite web 1 and/or the cover of the master element 4.

The arrangement can also be used to expose a transmission hologram in the light-sensitive composite web 1. In this case, the master element 4 preferably comprises a transparent substrate body and a transparent covering layer. For example, a reference beam can be directed through the lateral face of the master element 4 from above such that said reference beam is transmitted through a master hologram, the optical adhesive film 2 and the composite web 1. In an alternative, a reference beam can be directed at a base of the master element 4 such that said reference beam is refracted by the substrate body of the master element 4, and the refracted beam is transmitted through a master hologram 6, the optical adhesive film 2 and the composite web 1. In both cases, the reference beam is transmitted through the master hologram in part in undiffracted fashion and in part diffracted in order to create an object beam that likewise passes through the optical adhesive film 2 and the composite web 3. Consequently, the reference beam and the object beam superimpose in the light-sensitive layer of the composite web 3 with the same beam direction in order to create the replicated hologram. Additionally, the optical adhesive film 2 prevents unwanted optical losses and internal reflections at the interfaces, in order to obtain a high-quality transmission hologram.

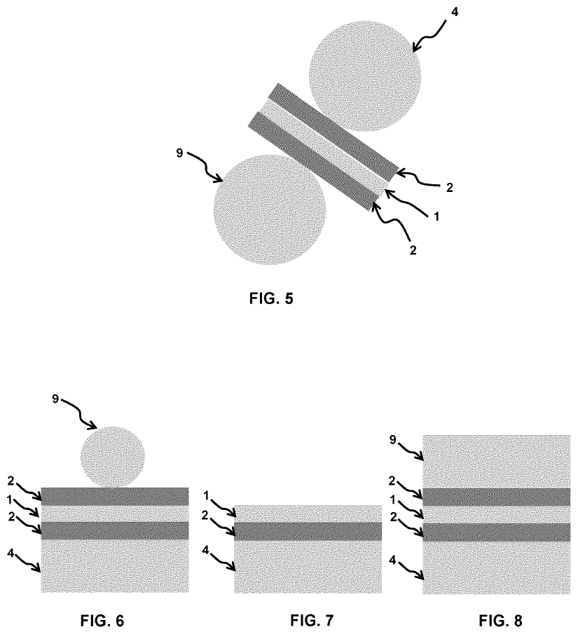

FIG. 5 schematically shows a further exemplary arrangement for replicating a hologram using optical adhesive films according to the invention. Two optical adhesive films 2 are used in this example. A first optical adhesive film 2 is arranged between a rotatably mounted cylindrical master element 4 and a light-sensitive composite web 1. A second optical adhesive film 2 is arranged between the light-sensitive composite web 1 and a cylindrical input coupling element 9. For example, this arrangement can be used to expose a reflection hologram in the light-sensitive composite web 1. The reference beam can be steered through the input coupling element 9—either through its lateral face or base—in such a way that said reference beam is incident on the master hologram on the lateral face of the master element 4 at a desired angle. Then, a reflection hologram can be exposed in the light-sensitive composite web 1 in a similar way, as described above for FIG. 4. The input coupling element 9 can advantageously set the angle at which the light-sensitive composite web 1 is exposed. However, this arrangement increases the number of different interfaces that the light must cross for the exposure. It is therefore particularly advantageous to apply optical adhesive films 2 to both interfaces between the various exposed process components (input coupling element 9, composite web 1 and master element 4) in order to avoid unwanted optical losses and reflections.

FIG. 6 shows a further arrangement of the process components for replicating a hologram, in which the master element 4 has the shape of a parallelepipedal block. The top side of the master element 4 is laminated with a first optical adhesive film 2, a light-sensitive composite web 1 and a second optical adhesive film 2. By preference, the master element 4 comprises a substrate body, a master hologram and a transparent upper covering layer (not shown) which protects the master hologram. The master element 4 can be used to expose a reflection hologram into the light-sensitive composite web 1 with the aid of the input coupling element 9, for example as explained above for FIG. 5.

FIG. 7 shows a further arrangement, in which the master element 4 has the shape of a parallelepipedal block. An optical adhesive layer 2 is laminated onto the top side of the master element 4, while a light-sensitive composite web 1 is also laminated onto the top side of the optical adhesive layer 2. The master element 4 can be exposed to a reference beam by preference from above (i.e. in the direction of its top side), said reference beam traveling through the light-sensitive composite web 1, the optical adhesive layer 2 and a transparent covering layer (not shown) before being reflected back into the light-sensitive composite web 1 by the master hologram, in order to form a reflection hologram. In an alternative to the replication of a transmission hologram, the master element 4 can be exposed on its lower side or on a side face while its transparent block-shaped substrate body refracts the reference beam in such a way that the latter is incident on the master hologram at a desired angle. The reference beam can then be diffracted by the master hologram in order to form an object beam which interferes with the reference beam in the light-sensitive composite web 1.

FIG. 8 shows an arrangement analogous to that in FIG. 7, in which a block-shaped input coupling element 9 is placed above the second optical adhesive film 2. For example, the input coupling element 9 can be used to refract a reference beam in such a way that the latter is incident on the master hologram at a desired angle in order to expose a reflection hologram in the light-sensitive composite web 1.

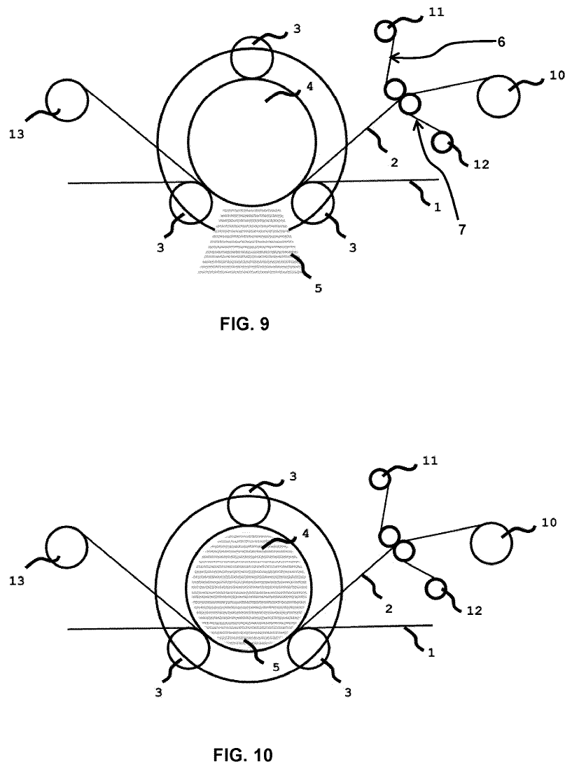

FIGS. 9 and 10 are a more detailed illustration of an exposure method with an arrangement analogous to that from FIG. 4.

FIG. 9 shows the exposure of a reflection hologram from the lateral face of a cylindrical master element 4. Transport rollers 3 are used to position a light-sensitive composite web 1 around a circular arc of the circumference of the master element 4 such that a significant part of the light-sensitive composite web 1 is in optical contact with the master element 4. By preference, a region of the optical contact corresponds to a circular arc of the circumference of the master element 4 which has an angle of at least 1°, preferably at least 2°. One or more of the transport rollers 3 can also be used to control the rotation of the master element 4 and/or the travel of the light-sensitive composite web 1 over the lateral face of said master element. In an alternative, the rotation of the master element 4 can also be caused by the friction that arises due to the movement of the optical adhesive film 2 over the lateral face of said master element. During the exposure, the light-sensitive composite web 1 moves from right to left.

An unwinding roller 10 is provided for unwinding an optical adhesive film 2. A rewinding roller 13 is provided for rewinding the optical adhesive film 2 used. The rewinding roller 13 can be an active roller which pulls the optical adhesive film 2 and thus controls its travel during the method. The optical adhesive film 2 is arranged in such a way between the light-sensitive composite web 1 and the lateral face of the master element 4 that it imparts optical contact between the lateral face of the master element 4 and a surface of the light-sensitive composite web 1.

The optical adhesive film 2 is provided with a protective layer 6, 7 on both sides. Rewinding rollers 11 and 12 are used to remove the protective layers 6 and 7 before the optical adhesive film 2 reaches the region of optical contact between the master element 4 and the light-sensitive composite web 1.

A reference beam 5 is directed to the master element 4 from below such that said reference beam passes through the light-sensitive composite web 1, the optical adhesive film 2 and the covering layer of the master element (not shown) prior to being reflected by the master hologram. The reflected object beam once again passes through the covering layer, the optical adhesive film 2 and the light-sensitive composite web 1, where it interferes with the reference beam in order to expose a reflection hologram into the light-sensitive composite web 1.

FIG. 10 shows an embodiment analogous to FIG. 9. However, the reference beam 5 is directed to a base of the transparent master element 4, where said reference beam is refracted in such a way that it emerges from a lower lateral face at a desired angle having passed through the master hologram. The reference beam is transmitted through the master hologram in part in undiffracted fashion and in part diffracted in order to create an object beam that likewise passes through the optical adhesive film 2 and the composite web 3. The undiffracted reference beam and a diffracted object beam interfere with one another in the light-sensitive composite web 1 in order to form a transmission hologram.

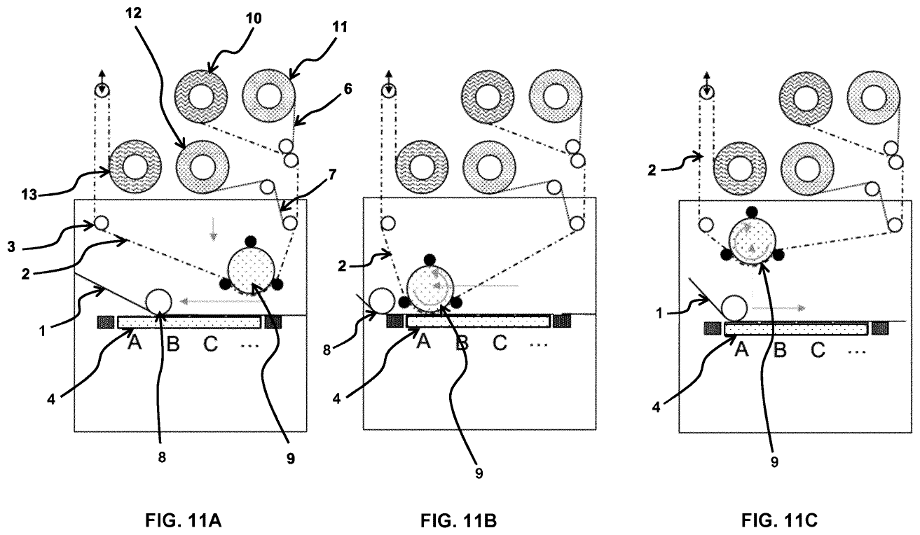

FIGS. 11A-11C show a method for replicating a hologram in a light-sensitive composite web 1 according to a preferred embodiment of the invention. FIG. 11A shows the step of applying a light-sensitive composite web 1 to the surface of a master element 4. The master element 4 is a parallelepipedal continuous plate that houses a plurality of master holograms A, B, C, etc. By preference, all master holograms are protected by a single transparent cover, and so the surface of the master element is continuous. A lamination roller 8 rolls over the stretched light-sensitive composite web 1 and presses the latter against the continuous surface of the master element 4 in order to eliminate possible air bubbles.

As depicted in FIG. 11A, the lamination roller 8 moves over the light-sensitive composite web 1, for example from right to left. At the same time, a transparent cylindrical input coupling element 9 is lowered in the direction of the laminated light-sensitive composite web 1. An optical adhesive film 2 is positioned over a circular arc of the circumference of the input coupling element 9 with the aid of various rollers. An unwinding roller 11 supplies the optical adhesive film 2 while a rewinding roller 13 rewinds the optical adhesive film 2 post exposure. The rewinding roller 13 can be an active roller—i.e. provided with an actuator—which pulls the optical adhesive film 2 and thus controls its travel during the method. Transport rollers 3 are used to set the position of the optical adhesive film 2 relative to the lateral face of the input coupling element 9. The movement of the optical adhesive film 2 from right to left can bring about a rotation of the input coupling element 9. The optical adhesive film 2 is provided with protective films 6 and 7 on both sides. These protective films are removed and rolled off prior to the exposure step with the aid of the unwinding rollers 11 and 12.

FIG. 11B schematically shows an application of the optical adhesive film 2 between the cylindrical input coupling element 9 and the light-sensitive composite web 1, in order to establish optical contact between the input coupling element 9 and the light-sensitive composite web 1. The input coupling element 9 is rolled from right to left over the top side of the light-sensitive composite web 1, whereby seamless optical contact arises between the master element 4 and the input coupling element 9. The optical adhesive film 2 is applied synchronously with the movement of the input coupling element 9. The region of optical contact moves from right to left here, together with the input coupling element 9. During the application of the input coupling element 9, light is used to expose the light-sensitive composite web 1 in the region of the optical contact. The light source (not depicted), for example a laser, can move synchronously with the input coupling element 9. This synchronous movement of the light source can preferably include scanning over the width of the light-sensitive composite web 1.

FIG. 11C shows the detachment of the input coupling element 9 from the exposed composite web 1. The cylindrical input coupling element 9 is lifted and carries the optical adhesive film 2, which continues to adhere to its surface. The lamination roller 8 is subsequently rolled back from left to right such that the exposed composite web 1 can be lifted and detached from the top side of the master element 4. Suitable means (such as further rollers) which can bring about the detachment of the composite web 1 from the top side of the master element 4 are known to a person skilled in the art.

While the lower parallelepipedal plate acts as the master element 4 and the larger transparent roller acts as input coupling element 9 in the example of FIGS. 11A-11C, the functions of these process components can also be reversed. For example, the lower plate can be configured as an input coupling element while the larger transparent roller is a master element. The light source can then be arranged accordingly and for example illuminate the input coupling element from a bottom face or a side face.

### LIST OF REFERENCE SIGNS

1 Light-sensitive composite web
2 Optical adhesive film
3 Transport roller
4 Master element
5 Light
6 First protective film
7 Second protective film
8 Lamination roller
9 Input coupling element
10 Unwinding roller for the optical adhesive film
11 Rewinding roller for the first protective film
12 Rewinding roller for the second protective film
13 Rewinding roller for the optical adhesive film
14 Carrier layer
15 First adhesive layer
16 Second adhesive layer

1. A method for replicating a hologram in a light-sensitive composite web, comprising the following steps:
a. providing a master element comprising a substrate body and at least one master hologram,
b. applying a light-sensitive composite web to a surface of the master element,
C. exposing the master element in order to replicate the at least one master hologram in the light-sensitive composite web, and
d. detaching the exposed composite web from the master element,
wherein the method further comprises a temporary application of an optical adhesive film between the light-sensitive composite web and the surface of the master element, said optical adhesive film imparting optical contact between the master element and the light-sensitive composite web while the master element is being exposed.

2. A method for replicating a hologram in a light-sensitive composite web, comprising the following steps:
a. providing a master element comprising a substrate body and at least one master hologram,
b. applying a light-sensitive composite web to a surface of the master element,
c. applying an input coupling element to the light-sensitive composite web such that the light-sensitive composite web is positioned between a surface of the input coupling element and the surface of the master element,
d. exposing the master element with the aid of the input coupling element in order to replicate the at least one master hologram in the light-sensitive composite web,
e. detaching the input coupling element from the exposed composite web, and
f. detaching the exposed composite web from the master element,
wherein the method further comprises a temporary application of an optical adhesive film between the light-sensitive composite web and the surface of the input coupling element, said optical adhesive film imparting optical contact between the input coupling element and the light-sensitive composite web while the master element is being exposed.

3. The method according to claim 1, wherein a refractive index difference between the surface of the master element and the optical adhesive film and/or between the optical adhesive film and a surface of the light-sensitive composite web is no more than 0.2.

4. The method according to claim 1, wherein a refractive index of the optical adhesive film is between the refractive index of the surface of the master element and the refractive index of a surface of the light-sensitive composite web.

5. The method according to claim 1, wherein the optical adhesive film comprises at least one adhesive layer, wherein the at least one adhesive layer has a peel force vis-à-vis the surface of the master element and/or a surface of the light-sensitive composite web of less than 3 N/cm.

6. The method according to claim 1, wherein the optical adhesive film comprises at least one adhesive layer, wherein the at least one adhesive layer has a Young's modulus of up to 50 MPa.

7. The method according to claim 1, wherein the optical adhesive film comprises at least one adhesive layer, wherein the at least one adhesive layer comprises an adhesive material based on acryl, EVOH, rubber or silicone.

8. The method according to claim 1, wherein the optical adhesive film has a one-layer structure comprising exactly one adhesive layer.

9. The method according to claim 1, wherein the optical adhesive film comprises a carrier layer and has at least one adhesive layer.

10. The method according to claim 9, wherein the at least one adhesive layer is present applied directly to the carrier layer, and a peel force of the at least one adhesive layer vis-à-vis the carrier layer is greater than a peel force of the at least one adhesive layer vis-à-vis the surface of the master element and/or a surface of the light-sensitive composite web and/or of a protective film.

11. The method according to claim 9, wherein the optical adhesive film comprises two adhesive layers.

12. The method according to claim 9, wherein the carrier layer has a tensile strength of at least 5 MPa.

13. The method according to claim 9, wherein the carrier layer comprises one or more of the following materials: polycarbonate (PC), polyethylene terephthalate (PET), cellulose acetate, triacetate (TAC), polymethylmethacrylate or mixtures thereof.

14. The method according to claim 1, wherein the optical adhesive film is provided with at least one protective film, wherein the at least one protective film is removed prior to the temporary application of the optical adhesive film between the light-sensitive composite web and the surface of the master element.

15. The method according to claim 14, wherein the at least one protective film comprises one or more of the following materials: polyethylene, polypropylene, silicone paper or mixtures thereof.

16. The method according to claim 14, wherein the at least one protective film is present directly on at least one adhesive layer, wherein the peel force required to remove the at least one protective film from the at least one adhesive layer is no more than 0.2 N/cm.

17. The method according to claim 7, wherein the at least one adhesive layer has a thickness of 50 μm to 250 μm.

18. The method according to claim 9, wherein the at least one adhesive layer has a tensile strength of up to 2 MPa.

19. The method according to claim 11, wherein each adhesive layer of the two adhesive layers is applied directly to the carrier layer.

20. The method according to claim 15, wherein the at least one protective film has a thickness of between 10-50 μm.
